(19) United States
(12) Patent Application Publication
(10) Pub. No.: US 2016/0264446 A1
(43) Pub. Date: Sep. 15, 2016

(54) FOAM GLASSY MATERIALS AND PROCESSES FOR PRODUCTION

(71) Applicant: FOAMYNA CANADA INC., Toronto (CA)

(72) Inventors: Abbas YOUSSEFI, Montreal (CA); Amir Hossein YOUSSEFI, Mashhad (IR)

(21) Appl. No.: 14/657,959

(22) Filed: Mar. 13, 2015

(51) Int. Cl. C03B 19/08; C03B 25/02; C03B 19/09

(52) U.S. Cl. CPC C03B 19/08; C03B 19/09; C03B 25/02

(57) ABSTRACT

Disclosed herein is a process for producing foam glassy materials. The process includes providing a precursor foam glassy formulation, the precursor foam glassy formulation comprising a micronized glassy material, in which the micronized glassy material being any one or any combination of ceramic opaque frits, transparent frits, flux frit, glazes, waste from kaolin processing, porcelain waste products, slag, cement, concrete, waste tile products and a foaming agent. The precursor foam glassy formulation is then processed to form a foam glassy product by firing the precursor foam glassy formulation to a temperature in a range from about 800° C. to about 900° C., followed by a step of annealing, followed by a step of cooling to produce a foam glassy product. The chemical, mechanical, physical properties of the final foam glassy material may be adjusted or tuned by adjusting the amounts of the various constituents making up the precursor foam glassy material.

### FIELD

The current disclosure relates to a method for producing foam glassy materials with adjustable chemical, physical, mechanical and optical properties using generally unrecyclable industrial wastes.

### BACKGROUND

Optimization of energy consumption is considered to be a major factor in the prevention of resource depletion and global environment impacts. Considering the options for integrating energy efficient construction materials such as foam insulators in domestic as well as industrial projects and plans is essential in reaching the goal of sustainability in energy consumption. Moreover, choosing locally manufactured technologies and service supplies rather than importing from other countries can save on energy consumed in transportation and storage.

Foam glass is a special building material and has been produced for many years which has been employed in various domestic as well as industrial applications since the early 1940's. As the name implies the internal structure of this material is similar to glass and the main component has always been obtained from glassy materials. Porous glass has desirable insulating properties. It is waterproof and has dimensional stability over long periods of time. It is inflammable and resistant to corrosive environments except hydrofluoric acid (HF). It is moisture resistant and a good defense against rotting and molds, problems that can devalue living areas and cause serious health issues. Porous glass is a light weight material, which is fire retardant and seals up structural cracks and crevices to make buildings more energy-efficient and free from hazards associated with pest infestation. Therefore porous glass may be considered one of the best building insulator materials for insulation against heat and cold. These properties have made foam glass excellent structural elements which may be used in future building interiors and common areas. They can improve the overall energy consumption of the building, control the raising energy charges and provide a more pleasant living atmosphere for the residents and occupants.

Foam glass is a light weight material with a closed-cell structure. It is made in molds that are packed with crushed, micronized or granulated glass mixed with a chemical agent such as carbon containing materials or limestone. At the temperature at which the glass grains (or particles) become soft enough to cohere, the agent gives off a gas that is entrapped in the glass melt and forms the closed-cell structure that remains after cooling. The main industrial uses of foam glass are for thermal and sound insulation. It is impervious to moisture, most fumes, and vermin.

In the past the main and sole producer in the world of foam glass was the Corning Company in the U.S. Recently other producers in Europe, Russia and China have also emerged. Until now, glass has been the main constituent in the production of glass foams. Calcium carbonate, calcium sulfate and coal have long been used as bubbling agents in the production of these foam glass materials.

In some production processes, glass production lines similar to glass tube have been used to prepare the required glass material. The formulated mixture of raw materials is fed into melting kilns and discharged in the form of tube rods. The glass tubes produced are rapidly cooled and crushed by special machinery before being loaded into ball mills. The bubbling and other-agents are added and the fine powder is prepared to undergo the next steps of shaping, firing and annealing. These are very expensive processes and have a significant influence on the final cost of the foam glass.

Glass and glass wastes have been the main raw material in almost all available production processes. Thus, relative to composition, foam glass is typically 100% glass, manufactured primarily from sand, limestone, and soda ash. These ingredients are melted into molten glass, which is cooled and crushed into a fine powder. In a typical process, the powdered glass is poured into molds and heated (below the softening point) in a heating process that causes the particles to adhere to one another. In some processes, a small amount of finely ground carbon containing material is added and the mixture is heated in a “cellulation” process. Here, the carbon reacts with oxygen, creating carbon dioxide, which creates the insulating bubbles in the foam glass. CO₂ accounts for more than 99% of the gas in the cellular spaces. The final step in the process is the stress relaxation of the manufactured items, which takes place in annealing kilns.

Scientific studies and research work in this field have so far concentrated mostly on issues such as low-density problems and/or improvements on the material micro-structural properties. Since typically, as noted above, conventional foam glass produced for industrial applications such as thermal and sound insulation uses 100% glass or waste glass, the various chemical, physical, mechanical and optical properties of the final foam glass are fixed and not adjustable.

There are many potential uses for foam glass and it would be very advantageous to provide a method of producing a foam glass material similar to foam glass in which the various chemical, physical, mechanical and optical properties can be tuned or adjusted. Thus, it would be very advantageous to provide a method of producing a foam glassy material similar to foam glass in structure with desired chemical, physical, mechanical and optical properties in an economic manner.

### SUMMARY

In the present disclosure, inorganic industrial and construction rejects are recovered in a way to generate suitable raw materials for foam glass production. Surprisingly, it has been found that the use of typically non-recyclable materials and product wastes from glass, frit and glaze, ceramic, mineral and iron producers can be used for the production of glass foams. Thus, these inorganic waste materials, which are normally stored in landfill or other dump sites make excellent starting materials for glass foam production.

In an embodiment, there is provided a process of producing a foam glassy material produced pre-selected physical, structural, mechanical and chemical properties, comprising the steps of:

a) providing a precursor foam glassy formulation, the precursor foam glassy formulation comprising a micronized glassy material, said micronized glassy material being any one or any combination of ceramic opaque frits, transparent frits, flux frit, glazes, waste from kaolin processing, porcelain waste products, slag, cement, concrete, waste tile products, foaming agents; and

b) processing the precursor foam glass formulation to form foam glass, including a step of firing the precursor foam glassy formulation to a temperature in a range from about 800° C. to about 900° C., followed by a step of annealing, followed by a step of cooling to produce a foam glassy product.

Optionally glass may be used.

A further understanding of the functional and advantageous aspects of the disclosure can be realized by reference to the following detailed description and drawings.

### BRIEF DESCRIPTION OF THE DRAWINGS AND TABLES

Embodiments will now be described, by way of example only, with reference to the drawings, in which:

FIG. 1 are optical photographs of foam glass structures produced by using ceramic waste frits and glazes of increasing SiC % content by weight, (shown on the right hand side and increasing from the bottom to the top of the figure), and for increasing firing temperature from 800° C. to 900° C. from left to right at the top of the figure, which shows the development of foam structure.

FIGS. 2a) to 2d) show optical photographs of foam glass structures produced by using ceramic waste frits and glazes of increasing SiC content from 1% to 5% by weight and at a constant temperature of 850° C.

FIG. 3 shows an optical photograph of a foam glass structure produced by using ceramic waste frits and glazes in which the SiC content is 4% by weight and the firing temperature is 850° C. In this case the size of the cells are smaller than the sample with 5% SiC content by weight.

FIG. 4 shows an optical photograph of a foam glass structure produced by using ceramic waste frits and glazes in which the SiC content is 5% by weight and the firing temperature is 850° C. In this case the size of the cells are bigger than the sample with 4% SiC by weight.

FIG. 5 shows optical photographs of various samples of foam glass produced in accordance with the present invention showing the development of foam structure and its effect on water absorption in different samples produced by using ceramic waste frits and glazes with increasing % SiC content by weight and increasing temperatures during firing.

FIG. 6 shows a scanning electron microscope (SEM) images of the homogeneous micro-structure of foam glass with approximate uniform cellular shape and sizes obtained by using waste of ceramic frits and glazes under firing condition of 800° C. and 30 minutes for the firing cycle and a SiC content of 3% by weight.

FIG. 7 shows a scanning electron microscope (SEM) images of the homogeneous micro-structure of foam glass with approximate uniform cellulare shape and sizes obtained by using waste of ceramic frits and glazes under firing condition of 800° C. and 30 minutes for the firing cycle and a SiC content of 4% by weight.

FIG. 8 is a scanning electron microscope (SEM) image of the homogeneous microstructure of cellular foam glass with approximate medium cell sizes of 400 to 600 microns made from ceramic frits and glazes.

FIG. 9 is a scanning electron microscope (SEM) image of the damaged microstructure of foam glass obtained by using waste of ceramic frits and glazes produced under a firing condition of 900° C. and 30 minutes of firing cycles.

FIG. 10 is a scanning electron microscope (SEM) image of the full damaged microstructure of foam glass obtained by using waste of ceramic frits and glazes produced under a firing condition of 900° C. and 30 minutes of firing cycles.

FIGS. 11a and 11b show pictures of several different colored foam glasses produced using the methods disclosed herein. The photographs shown in FIG. 11a are enlargements of the first four (4) the samples shown in FIG. 11b, from the bottom of the glasses.

FIG. 12 shows photographs of foam glass produced in different shapes and colors using formulations containing ceramic waste frits and glazes, ceramic waste bodies, blast furnace fritted slags and building wastes such as cement and concrete.

FIG. 13a shows photographs of colored foam glass produced by using fritted slag with the formulations shown in Table 23, with SMFFC-1 (light brown), SMFFC-6 (blue green) and SMF*/2 white with no color (Table 8).

FIG. 13b shows photographs of colored foam glass produced by using transparent and opaque waste frit using formulations of Table 19.

FIG. 13c shows photographs of colored foam glass produced by using waste recycle glass using the formulations of Table 16 including WGC-12 (red-brown), WGC-9 (blue-green), and WGC-11 (red).

FIG. 14 shows photographs of colored foam glass using formulations from Table 23 produced by using the two different direct methods of Flow Charts 1 and 2 (SMFFC-6, SMFFC-2, SMFFC-3, SMFFC-4 and SMFFC-9) and Indirect method Flow Charts 3 and 4 (SMFFC*/2/Cu, SMFFC*/2/Cr, SMFFC*/Fe₂O₃, and SMFFC*/2/Co).

FIG. 15 shows a Flow Chart 1 which shows a known conventional process for the dry method of producing foam glass.

FIG. 16 shows a Flow Chart 2 which shows a “direct wet method” method of producing foam glass which uses as the starting material micronized glassy materials, foaming agents, optionally various additives to give the final foam glass desired physical properties, and optionally coloring agents depending on whether or not the final foam glass is to have a particular color.

FIG. 17 shows a Flow Chart 3 which is an indirect wet method of producing foam glass which includes mixing the micronized glassy materials of the direct method of Flow Chart 1 with micronized non-glassy materials as the starting raw materials.

FIG. 18 shows a Flow Chart 4 which shows an indirect dry method of producing foam glass which includes mixing the micronized glassy materials of the direct method of Flow Chart 1 with micronized non-glassy materials as the starting raw materials.

Table 1 shows the results for ten (10) different types of composition in which transparent (F-38) and opaque frit (3-655/2) refuse and MF frit are involved. All of ten formulas when subjected to the direct dry process (Flow Chart 1) and direct wet process (Flow Chart 2) resulted in foam glass being produced.

Table 2 represents formulas where recycled glass and frit wastes are used simultaneously to produce foam glass using both the direct dry process (Flow Chart 1) and direct wet process (Flow Chart 2).

Table 3 shows the samples where the front glass from flat screen monitors is used. Front glass is substituted in the formulas from about 10 to about 100% by weight to produce foam glass using both the direct dry process (Flow Chart 1) and direct wet process (Flow Chart 2).

Table 4 shows the samples where the recycle glass is replaced by funnel CRT glass to produce foam glass using both the direct dry process (Flow Chart 1) and direct wet process (Flow Chart 2).

Table 5 shows the chemical analysis of mix glass, flat glass, borosilicate glass (E-glass), ceramic transparent waste frit (F-38), opaque waste frit (3-655/2) and MF frit. The last frit is produced by fritting colemanite and boracite (Borate minerals) using the process steps shown at 50 in Flow Charts 3 or 4.

Table 6 shows direct inclusion of small quantity blast furnace slag in production of foam glass beside SMF frit and foaming agent using both the direct dry process (Flow Chart 1) and direct wet process (Flow Chart 2). No foam glass was produced.

Table 7 shows direct inclusion of large amounts of blast furnace slag in addition to using MF frit but not using any foaming agent, using both the direct dry process (Flow Chart 1) and direct wet process (Flow Chart 2). No foam glass was produced.

Table 8 shows compositions of foam glass containing SMF (Table 9) and MF frit prepared using both the indirect wet process (Flow Chart 3) and indirect dry process (Flow Chart 4). No foaming agent was used and foam glass was produced.

Table 9 shows two frit compositions (MFCEM and SMF) prepared using waste cement, MF frit and slag from blast furnace to prepare foam glass using both the indirect wet process (Flow Chart 3) and indirect dry process (Flow Chart 4).

Table 10 shows foam glass production using a mixture of SMF (fritted Slag+MF+Kaolin), and MFCEM (fritted refused cement+MF+Kaolin) using both the direct dry process (Flow Chart 1) and direct wet process (Flow Chart 2).

Table 11 shows foam glass production using waste glass, clay and kaolin with increasing amounts of kaolin using both the direct dry process (Flow Chart 1) and direct wet process (Flow Chart 2).

Table 12 is similar to Table 11 and shows foam glass production using waste glass, clay and kaolin with increasing amounts of kaolin using both the direct dry process (Flow Chart 1) and direct wet process (Flow Chart 2).

Table 13 shows the characteristic (code numbers, color shade, oxide composition and density) of ceramic pigments (stains) used for producing color foam glass by direct method of Flow Chart 1 and 2.

Table 14 shows the different color foam glass compositions produced by using 1% by weight of foaming agent and 4.40% by weight ceramic pigment inclusion in mixed glass fired in 900° C. for 60 minutes using the methods of Flow Charts 1 and 2.

Table 15 shows foam glass formulas of similar composition to Table 14. In this case the foaming property is improved by increasing the foaming agent (SiC) to 2% by weight. This addition does not change significantly the shade of the foam glass pigmentation using the methods of Flow Charts 1 and 2.

Table 16 shows the effect on color of resulting foam glass using different ceramic pigments in a mixture of flat and mix glass. It can be seen that some of them are not suitable for producing color foam glass. The presence of flat glass does not change the firing condition and color shade of the resulting foam glass.

Table 17 shows that replacing flat glass with mixed glass results in changes in foaming property and color shade of the foam glass. The presence of a small amount of ceramic frit (F-38) in the last four (4) formulations modified the foaming properties and color shade to give a higher quality colored foam glass, and in addition the firing time advantageously was reduced to 30 minutes from 60 minutes.

Table 18 shows the effect of the presence of different amounts of transparent frit (F-38), opaque frit (3-655/2), flux frit (MF) with waste flat and mixed glass on the color and foaming property of the resulting foam glass.

Table 19 shows that by increasing the amount of transparent frit waste F-38 to around 60% by weight in the composition of the foam glass creates the best conditions for producing excellent quality of the resulting colored foam glass. All ceramic pigments were stable and a lower amount of pigment may be used for the same shade of color. Furthermore, their physical and chemical properties are unique. In general, the present studies indicate that the presence of ceramic frits and glazes in the foam glass formulation results in higher quality compared to foams produced using waste glass only. Without being bound by any theory, the inventors contemplate that this may relate to the expansion of the range of firing zone which gives greater control not only over the physical and chemical properties of the foam glass but also the quality of color when ceramic pigments are included in the foam glass formulations. It is believed that the presence of oxides of for example boron, zinc, aluminum, zirconium and barium (materials not normally present in foam glass compostions) in the dry and wet processes gives better characteristics to the final foam glass.

Table 20 shows colored foam glass produced from a mixture of waste glass and waste CRT front glass. These compositions improved color quality in some of the samples. The firing temperature was reduced by 50° C. compared to the composition containing the transparent frit F-38 (Table 19).

Table 21 shows the compositions of self colored glass frits obtained by melting the different compositions in which the different transition metal oxides are included to generate color in the glassy materials after melting in 1400° C. (in method step 50 in Flow charts 3 and 4). These frits are then used to produce colored foam glass using the remaining method steps in the Flow Charts. Lower firing temperature and less foaming agent are used in the foaming process.

Table 22 shows the self colored foam glass frits obtained from Table 21 are formulated to produce colored foam glass by using the indirect methods shown in Flow Charts 3 and 4). The Introduction of the new fritted materials (SMF) which are produced by melting the mixture of furnace slag with MF frit (Table 9) according to the indirect method explained in Flow Charts 3 and 4 is considered by the inventors to be a breakthrough in color foam glass fabrication.

Table 23 shows two groups of different colored foam glass compounds prepared using the both direct and indirect wet and dry methods of production Flow Charts 1 to 4. The first group use formulations of SMF frit+MF frit+kaolin and ceramic pigments (R71503 down to R71222 above the transition metal oxides shown in the left hand column in the Table 23) produced by using the direct wet and dry methods shown in Flow Charts 1 and 2. The second group has similar formulations to the first group but where the ceramic pigments are replaced by transition metals (chromium, cobalt, copper and iron oxides as shown in the Table 23 below the R series of color pigments) and are produced by using indirect wet and dry method Flow Charts 3 and 4 for comparison. Considering their ideal low temperature firing conditions (820° C.) for both groups as compared to foams produced with other glassy constituents, makes them environmentally friendly products with great savings in energy costs for their production. Furthermore, as the new samples do not require any foaming agent for the foam glass production, the quality of the finished colored foams are considerably increased. This characteristic creates beautiful color shades. All the composition in Table 23 produced excellent colored foam glass.

Table 24 shows the broad range of materials, and firing conditions used for all color and colorless foam glasses produced according to the direct methods of Flow Charts 1 and 2, and the indirect methods of Flow charts 3 and 4.

### DETAILED DESCRIPTION

Various embodiments and aspects of the disclosure will be described with reference to details discussed below. The following description and drawings are illustrative of the disclosure and are not to be construed as limiting the disclosure. Numerous specific details are described to provide a thorough understanding of various embodiments of the present disclosure. However, in certain instances, well-known or conventional details are not described in order to provide a concise discussion of embodiments of the present disclosure.

As used herein, the terms, “comprises” and “comprising” are to be construed as being inclusive and open ended, and not exclusive. Specifically, when used in the specification and claims, the terms, “comprises” and “comprising” and variations thereof mean the specified features, steps or components are included. These terms are not to be interpreted to exclude the presence of other features, steps or components.

As used herein, the term “exemplary” means “serving as an example, instance, or illustration,” and should not be construed as preferred or advantageous over other configurations disclosed herein.

As used herein, the terms “about” and “approximately” are meant to cover variations that may exist in the upper and lower limits of the ranges of values, such as variations in properties, parameters, and dimensions. In one non-limiting example, the terms “about” and “approximately” mean plus or minus 10 percent or less.

As used herein the phrase “foam glassy material(s)” refers to foam product produced from precursors formulation which has a glassy structure. This is to distinguish the new foam materials produced herein from the conventional foam materials which are called “foam glass”, and which are produced using only glass. The present “foam glassy materials” may be produced from constituents that do not include glass, or glass may form one of the constituents.

As used herein, the word “frit” refers to a homogenized mixture of inorganic materials that has been fused and melted in rotary or static continuous kiln, and quenched and crushed to form crushed glassy particles, flakes and or granules. Frits form an important part of the batches used in compounding ceramic glazes and vitreous enamels when producing foam glass. The purpose of this pre-fusion is to render any soluble and/or toxic components insoluble by causing them to combine with the silica network and other added oxides.

The process of making foam glassy materials disclosed herein is focused on either the direct wet method using typical glassy starting materials used to make foam glass, or an indirect method, wet or dry, which uses both typical glassy starting materials as well as other inorganic non-recyclable ceramic frits and glazes, ceramic body, waste glass, enamels, reclaimed cement, slag, mineral materials (excluding perlite), natural glass and waste or broken glassware which are first fritted to convert them to a glassy structure, then mixed wet or dry, with the normal glassy starting materials.

In the present work MF frit is used as a correction medium and furnace slag is used as the foaming agent to develop such items as colored foams, enameled foams, colored granules and gravels. MF frit is produced from rapid cooling of melted Colemanite in cold water and its use in foam technology is an innovative procedure, which has not been reported previously.

The internal structure of ceramic frits is very similar to the glass. In addition to common oxides in the soda-lime-silica glass, other oxides such as aluminum, boron, zinc, barium and zirconium are also used. Therefore, frits can be considered as a suitable replacement for glass in making the foams.

Slag from the blast furnace iron production kiln is a non-metallic substance composed of 95% by weight silica ( SiO2), limestone (CaO), alumina (Al₂O₃) and magnesium oxide (MgO) and other alkaline elements. Minor elements such as carbon, manganese and sulfur compounds also exist in fewer quantities. Slag has a smaller density than iron and floats on top of the melt in the blast furnace. The production rate is estimated at 25-30% by weight of the pig iron output.

Rejected ceramic products and their glazes produced in the tile, sanitary ware and tableware industries have similar chemical and mineralogical compositions but with a different percentage of the glassy phase. These waste materials are ideal sources of raw materials for foam glassy material production according to the processes disclosed herein. In addition, waste from selected mines, and or mineral refineries and beneficiation plants are good additional sources of raw materials for foam glass production as disclosed herein. Finally, waste and rejected materials from the construction and building industry, such as cement, concrete, gypsum and bricks may also be utilized and tested in various foam glassy material recipes disclosed herein.

### Preparation of Raw Materials

Foaming agents

Pure silicon carbide (SiC) is a foaming agent used in known foaming processes and it is used to produce the standard type of foam glass from the normal glassy starting materials. Advantageously, in the present process disclosed herein many of the inorganic non-glass materials used act as foaming agents so that a foam glassy product can be obtained with a reduced amount of SiC compared to the amount used in conventional foam glass production. As a non-limiting example, different percentages of iron and manganese compounds or mixtures thereof have been formulated and stabilized at a temperature <1300° C. before being added to the ceramic materials. These compounds are very effective as foaming agents and show very effective Redox properties at elevated temperatures thereby facilitating the foaming behavior. Additional additives may be included as foaming agents to give darker colored foam glassy products, Non-limiting examples including graphite and carbon containing compounds, organic matter containing compounds, organic materials and ashes.

Other types of foaming agents may be employed to give white or colored foam glassy products, for example non-limiting examples include carbonates and sulphates. For example, slag produced in iron blast furnaces normally contains carbon, sulfur and phosphate gases. Part of these gases remain unchanged after fritting with MF, which will be oxidized during the foaming process in the new foam glassy formulations prepared using this material as a part of the formula. The process could be discussed as below. There is a high amount of carbon in slag and when fritted the frit will contain a high amount of carbon and it will oxidize to CO₂ gas when fritted to render it glassy and mixed with standard glassy materials used to make foam glassy materials and this CO₂ gas will contribute to production of uniform sized cellules during the wet or dry indirect glass foaming processes disclosed herein.

Thus, this non SiC foaming agent(s) used in the processes disclosed herein promote formation of more uniform cellules and pores with controlled sizes in the final foam glassy product. It also produces foam glassy materials with white and/or pastille colors in a reduction/oxidation atmosphere. On releasing sulfur and carbon gases, this foaming agent enhances development of more cellules in the firing process. Colored products can be obtained either by direct addition of ceramic coloring agents or by making foams from existing colored frits and glasses.

### Sources of Frit

The following raw materials were used to prepare the required glass frit:

1) glass and frit waste from ceramic frits and glaze producer;

2) waste from tile body or glaze, from tile factories;

3) rejected products from body or glaze in sanitary ware manufacturer;

4) preparation of a frit named MF, waste transparent frit named F-38 in this disclosure and waste opaque frit named 3-655/2; MF is a frit made of a minerals containing Boron, Ca and Mg named Colemanite CaB₃O₄(OH)₃H₂O, and Boracite Mg₃B₇O₁₃Cl. The chemical composition of this mineral may changes according to the percentage of each minerals in the ore.

5) material waste from washing clay factories.

6) rejected products from body and glaze in china and porcelain producers;

7) reclaimed concrete and bricks from construction sites;

8) waste from mines;

9) slag from iron blast furnaces; and

10) different colored oxides or minerals used to produce glass color frits.

With respect to the fourth (4^{th}) material source mentioned above (MF), it is noted that borate minerals such as Colemanite and Boracite have a high content of calcium and magnesium as an impurity and is considered as a waste material in boron mines. This is a useful source of cheap boron for the present method of foam glassy material production disclosed herein. It can be converted to a glassy state after melting and produced a frit, named MF frit. The inventors have found this frit is very useful in foam glassy material production when used in conjunction with other waste materials generated in mines or ceramic and/or iron manufacturing. The indirect methods, both the wet and dry processes shown in the Flow Charts 3 and 4 discussed hereinafter are very suitable processes for foam glassy product production.

So far waste glass has been the only component use for producing foam glass insulators. In the present disclosure, waste glass in combination with other materials with similar physical and chemical characteristics to glass have been used for production of foam glassy products. In addition to the MF frit materials discussed above, these materials include rejected frits from frits and glazes producers, rejected glaze and body from ceramic tiles, chinaware, sanitary ware manufacturers as well as wastes from television and monitor screens (CRT), laboratory glassware, ampoules, light bulbs, rejected construction materials, slag from iron blast furnaces, waste from mines and clay beneficiation plants.

More particularly, waste from ceramic frit manufacturing plants may be used as the basic element in the present process for producing foam glassy products. Any kind of melted frit with an amorphous structure may be used in this process. An advantage of using frits over all other materials, for use as the base element in the present foam production process, is its basic glassy structure which provides more suitable physical and chemical properties to the final foam glassy product. As in any other industrial product, the chemical and physical characteristics of different frits can vary substantially which will have an impact on the chemical and physical properties of the glass foam so that desired final properties of the foam glassy product should considered when selecting the type of frit to be used. Some of the most important features are thermal expansion coefficient, softening point, viscosity, chemical and mechanical strengths. These properties play an important role in developing foams for specific applications and should be determined and adjusted prior to use in order to produce a high quality foam glassy products.

Using waste materials which have a glassy structure helps to keep the foam properties of the resulting foam glassy material under better control. For example transparent frits are effective in achieving darker colored foams. Opaque frits, on the other hand, can be used when lighter pastel colors are desirable.

By using waste from frit and ceramic production plants, a considerable saving in the final product cost is achieved. These materials are found in large quantities in manufacturing plants and are seldom used for other industrial purposes. It is important to note that a composition made from blast furnace slag or other waste materials from different sources mentioned above besides recycled glass prevents the production of cellular structure with homogeneous bubbles due to increase in the softening point. However, addition of ceramic frit into the composition allows one to use up to minimum of 20% by weight of these waste or slag materials to be used in the formulation with no adverse effects on the required homogeneity of bubbles. It is therefore advantageous to use some amount of frit in the production of the foam glassy products disclosed herein. The main gases in the slag are carbon, sulfur and nitrogen but also other gases are present. As the foam temperature exceeds its softening point, the gases are released to help in producing the desired cellular bubble structure in the final foam glassy product.

The use of waste ceramic frits that have much lower expansion coefficient in comparison to ordinary glass improves thermal shock resistance of the resulting foam. Therefore temperature fluctuations will be better tolerated. Moreover it is possible to produce colorful designs on the external surface of the foam glassy product to produce foam glassy tiles for exterior applications.

The use of suitable waste frits contributes to added flexural and wear strength in comparison to current glass foams, which are made solely from glass. Waste frits which have smaller density than glass, lead to low density and therefore lighter foam glass products. The important technical characteristics of foam glass include density, mechanical strength (flexural, compressive and tensile), thermal conductance, flammability, expansion coefficient and chemical strength. It is possible to fine tune these properties for each application area. Small changes in density can increase mechanical strength and alter other properties accordingly.

To summarize, one first determines any one or combination of desired physical, structural, mechanical, thermal and chemical properties to be exhibited by the final foam glassy product and then provides a precursor foam glassy formulation which will give this the desired foam glassy product.

For example, when mechanical strength (flexural, compressive and tensile) of the foam glassy product is being tuned and improved compared to regular foam glass, the precursor foam glassy product formulation can contain any one or combination of transparent frit F-38, opaque frit 3-655/2, flux frit MF and CRT front glass (TV).

There are in general two important factors which play a role in producing better quality foam glassy material with superior thermal, mechanical and chemical properties compared to conventional foam glass produced in the convention manner using just glass. The first factor relates to the chemical compositions of the foam glassy product and the constituent materials present which may change the microstructure of the final foam glassy product and controls the development of different phases in the final product. The second factor relates to the thermal processing conditions to which the starting formulations are subjected during production of the foam glassy product. The inventors have discovered that the presence of certain materials in the starting foam glassy formulations lead to novel and improved properties of the final foam glassy product.

The normal soda-lime—silica glass contain SiO₂ as a main constituent and it contains more than 70% by weight silica (SiO₂), 15% by weight sodium oxide (Na₂O) and 15% by weight other chemicals like calcium oxide (CaO) and magnesium oxide (MgO) which gives the stability to glass. It may also contain a small amount of alumina (Al₂O₃) to improve certain properties of glass. Glass has normally a very hight inherent strength but can be very weak in its surfaces because of surface imperfection or flaws which are responsible for its known fragility. The coefficient of thermal expansion is fairly high, so that is usually very weak when subjected to thermal stresses. Special surface treatment may reduce the number of surface flaws in order to increase the overall strength. The chemical durability is not well defined in contact with corrosive media and high PH value.

On the other hand there are some other glass compositions e.g. borosilicate glasses containing 70 to 80% by weight of silica (SiO₂), 7 to 13% by weight of boric oxide (B₂O₃) with small amounts of sodium oxide (Na₂O) and aluminium oxide (Al₂O₃). This kind of glass has exceptional resistance to thermal shock because of its low coefficient of thermal expansion and relatively high softening point. It is also durable in contact with water and water vapour. These glasses also exhibit good optical properties with the ability for transmitting light through the visible and near ultra-violet range of the spectrum. That these types of glasses have these properties relates to the presence of certain constituents, mainly boron oxide (B₂O₃) in the composition of the glass.

In the present disclosure, the inventors have discovered that it is possible to produce high quality foam glassy products with properties that can be tuned or adjusted depending on the materials used in the starting formulations. For example, using cheap starting materials such as waste frits and glazes the properties of the final foam glassy product could be controlled. These waste materials contain different oxides such as boron oxide, aluminum oxide, zinc oxide and zirconium oxide it is believed that these various constituents are responsible for improving the different physical, mechanical, chemical and optical properties of the final foam glassy product.

### Colored Foam Glassy Materials

High quality red and brown colored foam glassy material may be using the two different processes described in Flow Chart 1 to 4 which are given in Examples 1 and 2. In Example 1 some of the flat and mix glass is replaced by ceramic frits wherein the precursor foam glassy product formulation comprises a mixture of transparent frit F-38 (59.0 wt %)+flat glass (16.4 wt %)+flux frit MF (12.0 wt %)+kaolin (6.0 wt %)+foaming agent SiC (2.0 wt %)+red ceramic color R71622 (4.4 wt %)+Iron oxide Fe₂O₃ (1.0 wt %). This example corresponds to red sample WGTFC-4 of Table 19 and was prepared by using the direct dry and wet processes of Flow Charts 1 and 2 of direct method.

In an Example 2, a high quality of self-colored brown foam glassy material is produced by using the indirect processes of Flow Chart 3 and 4 wherein the precursor foam glassy formulation comprising a constituent named WGTV/Mn/1 * and is compounded by fritted self-colored glass WGTV/Mn/1 (95.0 wt %)+K-31 Kaolin (4.0 wt %)+foaming agent (1.0 wt %).

### Improved Mechanical Properties

The mechanical properties of the foam glassy materials studied herein were in general improved by replacing some (or all) of the glass by waste ceramic frits and this is due mainly to the lower coefficient of thermal expansion of the frit waste containing boron oxide, aluminum and/or zirconium oxide present in their formulation. Not being bound by any theory, the inventors believe this improvement may be related to the fact that the lower thermal expansion is able to help control the stresses that develop in the foam glass during cooling. One of the main factors leading to a reduction in mechanical strength of foam glass is micro cracks development which generates local stress concentrations in the foam glass product.

Table 2 shows the different compositions of foam glasses in which part of the normally used waste glass is replaced by different amounts of F-38 transparent waste frit (WGTF,WGTF/1 and WGT), 3-655/2 opaque waste frit (WGOF, WGOF/1, WOO) and MF flux frits (WFG). The foam glasses produced using these new formulations all exhibit a lower coefficient of thermal expansion compare to foam glass produced from waste glass alone.

Table 5, in which the chemical compositions of waste glass and ceramic waste frits are given for comparison, shows the difference in oxide constituents. The frits containing boron oxide B₂O₃, Al₂O₃ and ZrO₂ provide a lower coefficient of thermal expansion so that increasing the amount of these oxides in the foam glass formulations will decrease the coefficient of thermal expansion accordingly. This lower coefficient of thermal expansion is advantageous in being able to control the development of thermal stresses which may be the cause for micro cracks forming, and other flaws and imperfections developing in the final foam glass product. This affects the mechanical properties and will increase the tensile strength of the materials. Based on this it has been observed that the mechanical property improvement peaks in a foam glass made from only waste frits, absent any waste glass. Table 1 shows the foam glasses produced from only frits.

The hardness of glasses containing boron oxide (e.g. borosilicate glass) is about 2.3 times the hardness of flat glass. It is therefore expected the hardness of foam glassy materials produced according to the formulations of Table 1 are better than foam glassy materials produced by using mixed or flat glass in their composition.

Thus, for specific applications, when mechanical properties are being tuned or adjusted, such as the bending stress of colorless and colored foam glassy product can be increased by replacing flat and mixed glass with ceramic frits and in some cases with ceramic pigment. An exemplary precursor foam glassy formulation may be a mixture of transparent frit F-38 (59.0 wt %)+flat glass (16.4 wt %)+flux frit MF (12.0 wt %)+Kaolin (6.0 wt %)+foaming agent SiC (2.0 wt %)+red ceramic color R71622 (4.4 wt %)+Iron oxide Fe₂O₃ (1.0 wt %) .

When adjusting the cellular microstructure including size, shape, pores interconnection, interfaces thickness, pores and bubbles concentration and distribution in cellular structure a precursor foam glassy formulation may include a mixture of SMF frit (44.0 wt %)+MF frit (45.0 wt %)+K-31 (Kaolin (10.0 wt %))+ceramic pigment R71507 (1.0 wt %), see Table 23, sample SMFFC-7.

### Improved Chemical Properties

The inventors have concluded that the chemical resistance of foam glassy material increases by decreasing the alkaline content in the starting materials (sodium and potassium oxide) by replacing boron oxide and increasing aluminum and zirconium oxide content in the foam glassy compositions. Foam glassy materials produced with these formulations have been observed to resist most concentrated and /or dilute acids, alkalis, halogens and water vapor. In most of the cases studied herein (Tables 1, 2, 18, and 19) in which the mixed and flat glass are fully or partially replaced by ceramic waste frits the chemical resistance was observed to increase to acid and alkaline medias of different PH.

Thus when it is desired to adjust the chemical property such as chemical resistance of the foam glassy material in contact with different corrosive acidic and alkaline media of different pH, it is preferred to reduce the amount of, or remove any, mixed and flat glass and use opaque frit which increases the chemical resistance of the resulting foam glassy product. Such a precursor foam glassy formulation may comprise a constituent named WO (Table 1) which is a mixture of opaque frit 3-655/2 (98.5%)+foaming agent SiC (1.5%).

### Thermal Shock Resistance

The thermal shock resistance of foam glass increases by decreasing the alkaline content of the constituents in precursor foam glassy product compositions and by replacing the oxides with a lower coefficient of thermal expansion (aluminum oxide and zirconium oxide) with the oxides having a higher coefficient of thermal expansion. Boron replacement on the other hand produces a much lower coefficient of thermal expansion which will increase the thermal shock resistance of the foam glassy product.

### Thermal Conductance

When thermal conductance properties to be exhibited by the final foam glassy product is being tuned and improved compared to regular foam glass, it is known that the thermal conductivity of aluminium oxide is higher than other oxides in glass compositions. The thermal conductivity of magnesium and calcium oxides are a little lower than aluminium but much higher than barium oxide. Most of the ceramic frit materials contain a high amount of aluminum oxide, calcium oxide and in some cases magnesium oxide in their formulation as in the case of transparent frit F-38, opaque frit 3-655/2 and MF flux frit (Table 5).

In foam glass more than 85% of the volume is occupied by carbon dioxide and other gases with a low thermal conductivity, e.g. CO₂ is 0.016 and air is 0.045 W.m-1.k⁻¹. This modification in the structure may affect the thermal conductance quantity of such oxides in the resulting foam glass.

The foam glassy products produced by the processes disclosed herein are non-combustible materials because they are a glassy inorganic material which contains no binders or filler so that it will not absorb flammable liquids or vapors.

When the density to be exhibited by the final foam glassy product is being tuned and improved compared to regular foam glass, it is noted that the density of waste frits may vary according to the amount and type of oxide present in the composition of the frits. Aluminum, zirconium, barium, calcium and magnesium oxides increase the density in transparent and opaque frits. Therefore the replacement of mixed or flat glass by ceramic frits increases the overall density of the final foam glassy product by a very small factor. However, the main factor in determining the density in foam glass is the configuration, size, numbers and distribution of the cellular structure and this will have a significant impact on the density of the final foam glass product. Adding some ceramic pigment or metal transition oxide to the precursor foam glassy compositions can produce significant changes in the density of foam glassy product according to the wt. % added. This phenomena was observed in several cases.

The optical property in frits is very similar to borosilicate glass discussed above so that high quality colored foam glassy materials can be produced when ceramic pigments are added to the precursor formulations. The ability for transmitting light through the visible and near ultra-violet range of spectrum creates a better condition regarding the color intensity. Flat and mixed glass with the soda-lime-silica composition normally have a low index of refraction and high dispersion value which means the light does not significantly interact with the constituents of glass and the ceramic pigments added to their composition does not reflect the real color of the pigment in some case (Table 14 to 17). Replacing part of the waste flat and mix glass with waste CRT front glass containing barium oxide (Tables 20 to 22), transparent frit (F-38) and/or opaque frit (3-655/2) with the same amount of ceramic pigment (Tables 17 to 19) in foam glass will produce a higher index of refraction and a very good color quality of the final foam glassy product. From Table 17, comparing WGC22 with WGTC1 shows how the replacement of only 10% of frit with glass can change the quality of colored foam glassy produced.

The two methods illustrated in the Flow Charts 1 to 4 show that the production of foam glass using the materials disclosed herein can be carried out either by a direct or an indirect method. The samples are primarily associated with the various light weight foam glasses with glassy structure. The raw materials used in the process, come from wastes of glass and ceramic manufacturing units including tile, sanitary ware, tableware, frit, glass hollowware, sheet glass, car shield window, television, monitor and slag from iron blast furnaces. Waste from clay washing plants, mines, stain and pigment industries and finally bubbling agents constitute other additives. Using different formulations and raw materials, a wide range of foam glasses for specific applications have been produced and tested.

The present process uses a new frit material based on a mineral known as colemanite. This frit is called MF and is produced by quenching the melt in cold water and is an inexpensive flux frit. The presence of this MF frit mixed with any other types other ceramic components during melting can modify their structure to a homogeneous glassy state suitable for foam glass production. It is anticipated that it will produce the same sort of properties with other waste materials as such rejects obtained from mines, mineral processing and washing clay plant. In the new process disclosed herein, slag, which is obtained from steel furnaces, may be used as the bubbling agent as well.

As noted above, preparation and production of colored or colorless foam glasses is performed by either the direct (no melting) process, or the indirect (melting) process with these processes being illustrated in Flow Charts 1 to 4 to be discussed in further detail below. In the direct method, all the ingredients are weighed and mixed, molded as required and then fired to make the final product.

In the indirect method, the mixture of constituents is melted in rotary or continuous kilns. After being quenched in cold water the resulting frit can be used from about 50 to about 100% by weight in making the glass foam. Another property that is directly related to foam glass application is its chemical stability in media of different pH value. Increasing this property to control the rate of release of heavy metals and to have a standard level of toxic leachate is significant issue when different percentages of CRT glass is incorporated into some foam compositions. It has been found that it is possible to stabilize and have a very resistance glassy structure with zero leaching of heavy metals.

### Frit Production Cycle

With the high growth in tile and porcelain industries, and the increasing worldwide demand for replacing old traditional floor coverings with more fashionable ceramic tiles, frit production has expanded accordingly to supply the most basic and important element in the tile design and quality.

In conventional frit production, a carefully weighed mixture of powdered materials is melted in a rotary or continuous kiln. Then the resulting melt is quenched in running water and the so-called frit is obtained. Frits have a glassy structure and can be classified as transparent, opaque and mat in accordance with their final appearance when applied on the tile.

Transparent frits, as the name implies, have good transparency with a good degree of light transmission capacity. Opaque frits on the other hand, are white with very low light transmission properties. In the ceramic industry, transparent frits are used with stains to yield dark colors whereas opaque frits tend to generate lighter and more pastel colors.

An example process for frit production is as follows. First, the components including raw materials, especial frit, wastes, glass and clay are weighed according to the formula. Then composition is melted in a ceramic crucible for about 2 hours at about 1200 to about 1450° C. The frit is prepared by pouring the melt into cold water. If a colored foam is desired, a suitable transition metal oxide is added to the frit composition (as shown in Flow Chart 3 and 4).

### Preparation Of Flux Frit (MF Frit)

MF is an auxiliary frit for adjusting the melt viscosity. It promotes consistency in the foam formation procedures. The mineral used in making the frit MF is colemanite, also known as borate calcium hydrate with the chemical formula B₂O₃-36%, CaO-25%, MgO-16%, SiO₂-4%, and H₂O-19% by weight. The material is melted in a rotary kiln and discharged into cold water to produce MF frit with the glassy structure. This frit can be used as a flux from 10% up to 50% by weight in either the direct or indirect methods of producing various foams. Table 5 shows the chemical composition of MF frit.

### Preparation of the Composition

The final formulation for making the foams may contain from about 0% to about 99% by weight of the especial frits, MF flux, transparent frit F-38 or opaque frit 3-655/2 which as mentioned above is primarily made to be added to wastes and rejects and may be obtained from different sources such as ceramic and glass factories. These materials are then weighted and mixed in proper ratios with MF frit, which plays an important role in the foam production and Clay. The mixture of materials prepared in the previous stage is ground in ball mill to reach the desirable particle size with about 1 to 2 gram remaining on 325-mesh sieve. Various forming techniques can be applied which include pressing, extrusion and casting and may be produced in any desired shape.

The items in various shapes undergo the final firing stage after being completely dried. The firing temperature ranges between 800° C. to 1000° C. with different time cycles to obtain the foam glass. The end products are then stress-relieved in special annealing kilns. The annealed foam products are easily cut to desired sizes in accordance with required specifications.

The present processes disclosed herein are very advantageous in that the costly process of producing glass granules is eliminated and glass is virtually replaced by frit wastes and rejects from tile and ceramic plants. This is a more cost-effective process which has not been used for making foam glass until now. The conventional glass furnace technology has been replaced by the more economic frit melting operations. Thus resulting in considerable time, energy and financial savings. At elevated temperatures in the firing zone, the CO₂, NO₂, or SO₂ gases are released, giving rise to plenty spherical and uniform bubbles which cause the material to expand in the glass softening range and thus create the foam.

The present disclosure provides two basic methods of producing foam glass, the two methods being referred to as the “direct” and “indirect” methods. Both these direct and indirect methods include both “wet” and “dry” methods of producing the foam glass.

### Direct Methods

### Direct Dry Method

Flow Chart 1 shows a known conventional process for the dry method of producing foam glass. The first step is to formulate and mix the appropriate foam composition constituents, but no water is used. Then following the homogenization process by drying milling in step 22, the desired final shape can be achieved by employing any of the methods mentioned below in step 26.

As seen from Flow Chart 1, the slip may be subjected to three (3) different shaping/forming and finishing processes, including granulating to form granules shown at 40, mold filling and pressing using refractory sheets shown at 42, and the third being open mold fluidizing shown at 44.

In the granulating process shown at 40, foam glassy materials in the form of granules with preselected desired sizes are produced using granulating machines. Water and binders are added to the homogenized mixture in the granulating machines. The granules are then dried before being transferred to a rotary firing kiln. The fired product is cooled, sieved and sized before being packed. This method is suitable for production of foam glass composites made from granules of different particle sizes mixed with either plaster or cement materials to produce light weight isolated coating or blocks with a very useful and beneficial thermal and noise control properties having different application in building and civil engineering.

In the mold filling process 42 the moulds are filled up with the dry homogenized powder material and after drying and pressing transferred to the firing kiln. Annealing is conducted in the next step to relax excess stress. Following this stage, the items may be cut to appropriate sizes and packed. This method is suitable for production of, slabs, blocks and boards of different shaps and sizes according to their application for inside walls, ceilings, or floors in the building industry.

In the open mold fluidizing method shown at 44, the mixture of powder materials is loaded onto a moving bed made of refractory metal. The raw material on the rotating metal bed continuously passes through the kiln to be fired at pre-determined temperatures. The fired foam is then crushed into spiky or 90 degree pieces under mechanical compressive forces followed by sieving and packaging. This method is suitable for production of foam glass gravel with sizes in a range from about 1 to about 8 cm for different applications as such building foundation, sports sites, green site, gardens, agriculture, parking area, roads and other civil engineering applications.

### Direct Wet Method

In the direct wet method, the main constituents are materials having a glassy structure. All recyclables and rejected products of mixed glass bottles, sheet glass, cars windows, glass TV monitors and glass computer monitors and all other glasses together with various frits (transparent, opaque, matt and colored glazes) and their waste can be transformed into glass foams according to the present process. These materials are considered to be the most suitable for this class of products. Additive may also be mixed in and used to establish the required properties such as foam ability, density adjustment, color, chemical and other physical characteristics.

Foaming agents are included, such as but not limited to silicon carbide (SiC) which is a very suitable material to develop cellular foams. The particle size is under 230 mesh and an addition of 0.5 to 4% by weight is used in the present methods.

Ceramic pigments (stains) may be including for producing colored foam glasses. These materials fall under the group of minerals with crystalline structures such as zircon, spinel, rutile etc. and metal oxides of chrome, cobalt, copper, iron, manganese, vanadium, praseodymium, cadmium, and synthesized selenium. Light colored foams use 0.5 to 3% by weight of ceramic color or oxides whereas darker foams can be produced using up to 5% by weight of coloring agents.

Ceramic frits with special compositions have been utilized in the development of all these new technological products, which are expected to make a significant impact in the future of the construction industry. Transparent frits are used to make dark colored foams while opaque and matt frits are incorporated in foams to give light and pastel colored glass foam. The opaque frit used in this process is coded as 3-655-2, the transparent frit is coded as F-38 and the flux frit is called the “MF” frit.

Referring to Flow Chart 2, the “direct wet method” method uses as the starting material micronized glassy materials, foaming agents, optionally various additives to give the final foam glass desired physical properties, and optionally coloring agents depending on whether or not the final foam glass is to have a particular color. In the first mixing step 10 shown in Flow Chart 2 the various solid starting constituents in their desired amounts are mixed together and with the desired amount of water and binder and the mixture, upon having the correct weight in step 20 is then intimately mixed and milled in step 22. If a final color is needed in the finished product, typically about 3 to 5 by weight coloring agents will also be added. The milled mixture is then homogenized and sieved in step 24 to ensure all particles are below a threshold size. After the mixture is homogenized and sieved, the resulting mixture, referred to as the slip, is then transferred to a blunger, typically a tank with a stirrer, prior to the shaping step 26.

As seen from Flow Chart 2, the slip may be subjected to three (3) different shaping/forming and finishing processes, including filter pressing, spray drying and slip casting. In Flow Chart 2 the slip casting process is shown at 30 on the right hand side of the Flow Chart and in the slip casting process, complex as well as simple shapes can be handled comfortably. A preferred water absorbing material is plaster of Paris. Plaster of Paris is preferred since it is very cheap and exhibits very water absorption properties especially for this kind of slurry. It absorbs water by capillary action of the plaster. A significant advantage of using plaster molds for slip casting as disclosed herein is the homogenizing of the material in the slip condition, after casting and drying and finally firing which produces a uniform foam glass cellular structure within the final foam glass. While Plaster of Paris is preferred as noted above, other water absorbing materials may be used. For example, another cheap mold material that may be used is wood which is suitable for shaping ceramic clay containing materials which has suitable plasticity. The moisture content of this material in this case is equal or more than 12% by weight.

The slip is poured into plaster mold(s) configured to give the final product with the desired shape(s). A significant amount of the water content of the slip is absorbed by the water absorbent mold. Once the partially dehydrated slip sets the shaped material is separated from the mold. At this time the partially formed foam glass product is transferred to a dryer and after drying it is transferred to a kiln to be fired at a pre-set temperature. The foam glassy product is stress relaxed in annealing kilns. The final foam product may be used as is or it may be cut into desired shapes and sizes and packed.

It will be appreciated that the final shape of the foam glass is not necessarily the same as its mold shape since foam glass final shape is normally obtained after being dried and removed from the mold at which point the foam glass may be cut up into desired sizes and shapes. The proposed plaster mold is for to produce raw shaped full foam glass body with a very low % by weight of moisture content to be ready for drying and firing.

This method is suitable for production of foam glass slabs, boards and blocks which advantageously avoids producing dust during materials preparation and the forming processes. The high water content used in the slip casting method and the loss of water after drying produces more cells with uniform sizes within the foam glass which have low densities thus making them suitable for high noise resistance applications. This process may also be used to produce shaped articles such as liners for pipes. Stress relaxation increases the thermal and mechanical resistance of the final foam glass product.

In the spray drying method, shown at 32 in Flow Chart 2, the foam glass slurry is transferred to spray dryer system in order to produce granules with about 1 to 6 by weight moisture content depending on the end application of the granules. In the spray drying process the slip is sprayed or jetted upwardly into a current of hot air so that the water in the particles is rapidly evaporated and produces a powder which drops down into a collection system. Fine particles or fine powders are collected by a cyclone and bag-filters. The temperature of the spray dryer, pressure of jetting and slip density are the main factors in controlling the moisture content of the spray dried powder.

In the next stage, the powder is either loaded into suitable molds and pressed to give foam blocks with predetermined shapes and sizes and then transferred to the kiln or it may be transferred directly to a firing kiln for the production of foam granules. After firing in the kiln, the granules are cooled and sieved to different granule sizes according to the end application. In the case of producing other bigger and shaped articles annealing is performed to relieve stresses and after cooling they are cut into the desired shapes and sizes and packaged.

This method is suitable for producing foam glass granules of different sizes according to the end applications. The granules of small sizes i.e. under 2 mm are suitable for mixing with plaster to produce the light weight plaster and for use as an isolation coating on walls. For the larger sizes i.e. greater than 2 mm, they may be mixed with cement materials to produce light weight loose or shaped concrete for different applications in building or civil engineering applications.

The third processing route is shown at 34 in Flow Chart 2 and is referred to as the extrusion method wherein the slip is injected into a filter press machine where excess water is removed and is then formed into filter cakes. The cakes preferably have a humidity between about 9 to about 12% by weight which are then loaded into extruders and extruded in the desired shape for the final product, after which the extruded articles are dried and fired in desired temperature range. To prepare the final foam glass objects, the items are annealed for stress relaxation and surface treated as needed. This method is suitable for production of hollow foam glass items most frequently used as protection jackets in liquid and gas transferring pipes.

### Indirect Methods

### Indirect Wet Method

Referring to Flow Chart 3, the indirect wet method includes mixing the micronized glassy materials of the direct method of Flow Chart 1 with micronized non-glassy materials as the starting raw materials. Referring to process 50 in Flow Chart 3, a selected amount of the non-glassy material is optionally mixed with a coloring agent and the mixture is melted and fritted, that is the micronized non-glassy material is fused in a fusing oven and quenched to form a glass, and granulated and micronized. This fritted micronized glassy material is then mixed with the other micronized glassy materials (glassy materials sited on the left part of the boxes) and the total mixture weighed in step 20 to obtain the desired amount of mixture. The process steps of milling 22, sieving 24, and shaping 26, are the same as described above with respect to the direct wet process of Flow Chart 1, with the shaping and finishing step 26 being including the same alternative processing steps as filter pressing process 34, spray drying process 32 or casting plaster process 30 in Flow Chart 1.

To produce a high quality foam glass with zero water absorption, uniform cellular structure and good mechanical properties, it is necessary, all the materials incorporate in foam glass production, are needed to be in vitreous or glassy state. This will stabilize the microstructure and prevent of any defects formation. Most of the non-glassy materials i.e., slag, building debris, waste of ceramic tiles and sanitary ware, waste and recycled materials of different industries, mines, concrete, cement and other materials obtained from such sources must be converted to the glassy states. In this process one needs to prepare suitable formulations and then melt and frit the non-glassy materials to a glass structure. In order to use the ceramic and other inorganic waste and recyclable materials as a part of foam glass formula, they first need to be converted to materials in a glassy state. The percentage of these constituents mixed in the usual glass foam starting materials will vary according to the final properties needed to be exhibited by the final glass foam product. By adjusting the amount of these originally non-glassy constituents in the foam glass composition, it is possible to tune the physical, mechanical, structural, and chemical properties of the final foam glass as the properties of these materials are quite different in comparison to the standard glass constituents, so that the their presence in the foam glass will change the resulting properties of the foam glass as a result of microstructure variations. In most of the studies conducted by the inventors it has been found that improvements in the physical, chemical and mechanical properties were obtained.

### Indirect Dry Method

Referring to Flow Chart 4, the indirect dry method includes mixing the micronized glassy materials of the direct method of Flow Chart 1 with micronized non-glassy materials as the starting raw materials. Referring to process 50 in Flow Chart 4 (the same as process 50 in Flow Chart 3), a selected amount of the non-glassy material is optionally mixed with a coloring agent and the mixture is melted and fritted, that is the micronize glassy material is fused in a fusing oven and quenched to form a glass, which is then ground and micronized. This micronized glassy material obtained from melting and fritting of non-glassy materials is then mixed with the micronized glassy material existing on the left side of Flow Chart 4 and the total mixture weighed in step 20 to obtain the desired amount of mixture. The process steps of milling 22, sieving 24 and shaping 26, are the same as described above with respect to the direct wet process of Flow Chart 2, with the shaping and finishing step 26 being including the same alternative processing steps as the granulating process 40, mold filling process 42 or fluidizing process 44 in Flow Chart 2.

Use of Transparent, Opaque Frit and Flux Frit waste in Foam Glass Production

In the present disclosure, a large number of foam glass compositions have been provided using various types of waste frit. Refuse frits have been taken from two major transparent and opaque classifications, referred to herein as F-38 (transparent waste frits) and F-3-655/2 (opaque waste frits) respectively. A low melting frit referred to herein as MF has also been prepared in order to produce foam glass having selected properties. This MF frit is used in making standard as well as colored foam glass products. Both dry and wet methods invented to process and produce foam glass of different compositions were applying to all the formulas studied.

Table 1 shows the results for foam formation for ten (10) different compositions in which different amounts of waste transparent, waste opaque, MF frits and kaolin (K-31) have been used as the starting material. The amount of foaming agent for each formulation was held constant at about 1.5% by weight. The firing temperature for all compositions was 850° C. and the heating cycle is about 30 minutes as shown in Table 1.

From the studies conducted by the inventors, and as seen from Table 1, foam glass can be produced using up to 98.5% by weight using opaque waste frit alone with a foaming agent at 1.5% by weight (such as but not limited to SiC), seen in the column entitled WO and up to 98.5% by weight using transparent waste frit with the same amount of foaming agent, shown in column entitled WT. The remaining columns from left to right show different formulations using mixtures of transparent waste frit and opaque waste frit with foaming agent, or mixtures of these two waste frits with kaolin, and MF flux frit along with the foaming agent in various amounts. It is noted that all formulations resulted in foam glass. Thus, based on the results of Table 1 it can be seen that any % by weight of either opaque or transparent waste frit from 0 to 98.5% by weight with or without MF frit will produce foam glass in the presence of foaming agent such as SiC.

### Study of the Advantage of Using Ceramic Frit Wastes in Foam Glassy Formulations

Table 2 shows the results for nine (9) different foam glass compositions selected from a number of tests in which opaque and transparent refuse frit and MF frit were mixed with recycled glass. All nine (9) formulations were converted to foam glass using both dry and wet processes of Flow Charts 1 and 2 under the same basic conditions of firing temperatures and times, (900° C. and 45 minutes) and all gave good quality foam glass. Some formulations were prepared without addition of any MF, opaque and transparent waste frit but were made using waste flat glass (see column entitled WG) and a combination of waste mixed glass and waste flat glass (see column entitled WG/1).

The formulations in Table 2 were prepared in which part of the glass was replaced by MF frit, opaque waste frit and transparent waste frit, were formulated (see columns entitled WGF, WGO and WGT. Other formulations were prepared in which some of the ceramic frits were replaced by using MF frit (see columns entitled WGTF, WGTF/1, WGOF and WGOF/1). As can be seen from Table 2 the same amount of kaolin (K-31) and foaming agent were used for all the samples.

Characterization of the samples of Table 2 produced by both wet and dry preparation processes reveals it is possible to obtain new foam glass products with improved physical, mechanical and chemical characteristics over the standard foam glasses. In addition to maintaining the same standard properties required by foam glasses, use of the new additional starting materials allows for flexibility to alter the density and other physicochemical specifications of the foam glasses to suit specific applications which can be achieved by the broader firing temperature ranges possible when these additional starting materials are used. In other words, suitable modifications will be handled more readily and with less trouble. This allows for adjustments in the cellular density, size and dimensions, cellular distribution and connectivity as well as improvements in mechanical and chemical properties, which allows for the achievement of superior physical and acoustic behavior, reduction in thermal conductivity, increasing color variations and production of multi-colored foam glasses.

The results in Table 2 show that addition of even small amounts of ceramic frits (5 to 10% by weight) can have a significant influence on foam properties and cause several advantages as listed below. The above study of samples made waste frits F-38 and 3-655/2 with the low melting MF frit, provided new foam glass products with improved characteristics over the standard glass type foam glass. In addition to being able to produce foam glass with essentially the same standard properties as obtained with regular foam glass, there is the additional advantage of being able to alter or tune the density and other physicochemical properties of the foams to suit specific applications depending on the non glassy components used and broader firing ranges that can be used compared to production of regular foam glass. In other words, suitable modifications will be handled more readily and with less trouble. The ability to tune, or adjust various properties results in foam glass with superior mechanical and chemical properties, superior physical and acoustic behavior, reduced thermal conductivity, increased ability to produce a foam glass with a large selection of colors are only some of the advantages gained when ceramic frits are included in the starting formulation.

The results show that addition of even small amounts of ceramic frits (5-10% by weight) can have a significant influence on foam properties and provide several advantages including 1) a reduction of the firing temperature to 900° C., which is a reduction from 50° C. to 100° C. compared to regularly produced foam glass which is typically in the range from 950 to 975° C.; 2) a reduction of the firing time (down to 45 minutes) of 10 to 30 minutes in the firing cycle compare to the standard operating cycle time of 60 minutes; 3) production of a strong cellular structure and improved mechanical strength; 4) a reduction of surface water absorption of the foam glass; 5) reduction and better control over the melt viscosity; 6) a reduction of amount of SiC foaming agent required compared to regularly produced foam glass; and 7) an improvement of the microscopic structure of the foam glass.

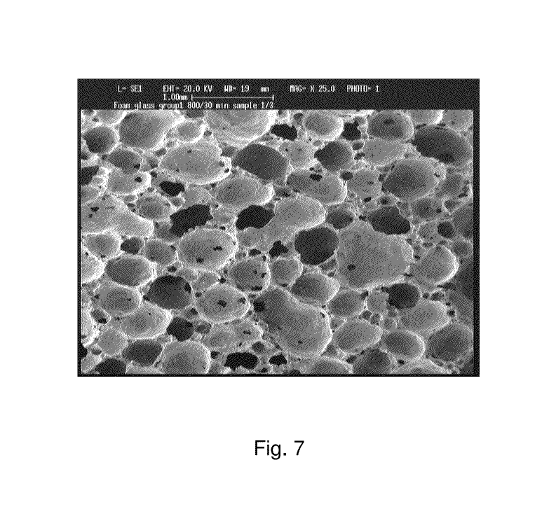

It is noted that if the constituents of the melt are such that the melt exhibits high viscosity or a high softening point, this may be the main reason for the need for elevated firing temperatures (>950° C.). An important condition for obtaining high quality production is strict observance of optimum temperature conditions in the firing zone, disruption of which leads to poorer foam glass quality and additional losses of fuel energy. In the foam glass industry, viscosity plays an important role in configuring the optimum thermal conditions. As the melt softening point increases, so does the firing temperature. This has an adverse effect on the isolation of cells resulting on them being more open and exposed to water absorption which eventually reduces the foam glass quality and restricts their range of applications. Alleviation of softening point temperature and firing the items below 950° C. promotes cellular isolation and considerably reduces water absorption thereby resulting in a superior foam glass. The Scanning electron micrographs of FIGS. 6 to 10 discussed herebelow show these structural changes at high temperatures.

Scanning electron microscope (SEM) studies have confirmed the above results and it is noted that raising the temperature gradually ruins the cells' shapes and provides connections between them. For example, FIG. 6 shows a scanning electron microscope (SEM) image of the homogeneous micro-structure of foam glass with approximate uniform cellular shape and sizes obtained by using waste of ceramic frits and glazes under firing condition of 800° C. and 30 minutes for the firing cycle and a SiC content of 3% by weight.

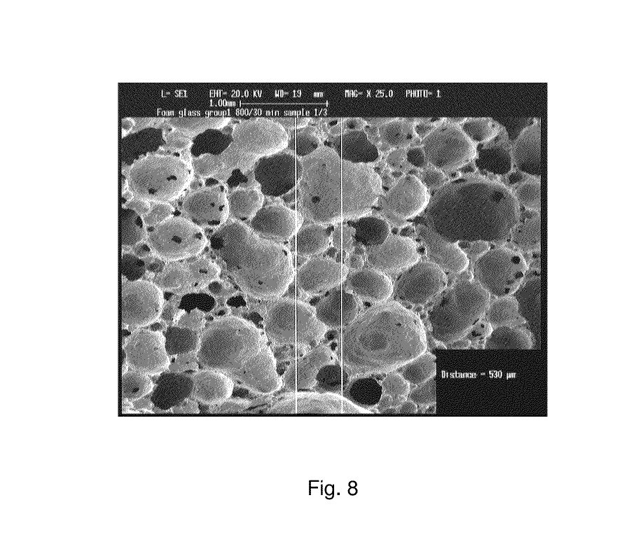

FIG. 7 shows a scanning electron microscope (SEM) image of the homogeneous micro-structure of foam glass with approximate uniform cellular shape and sizes obtained by using waste of ceramic frits and glazes under firing condition of 800° C. and 30 minutes for the firing cycle and a SiC content of 4% by weight.

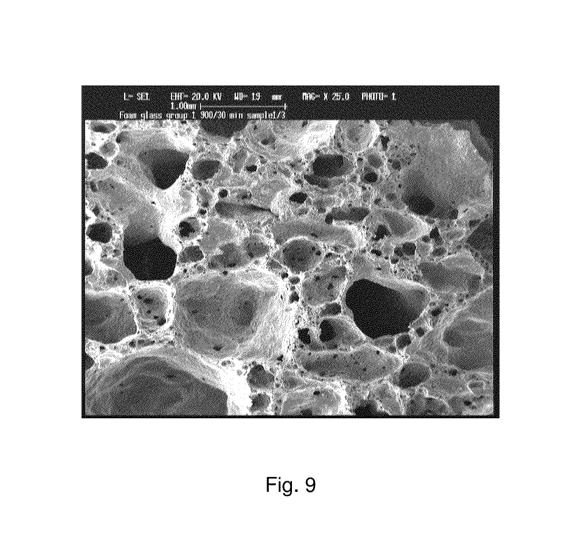

FIG. 8 is a scanning electron microscope (SEM) image of the homogeneous microstructure of cellular foam glass with approximate medium cell sizes of 400 to 600 microns made from ceramic frits and glazes.

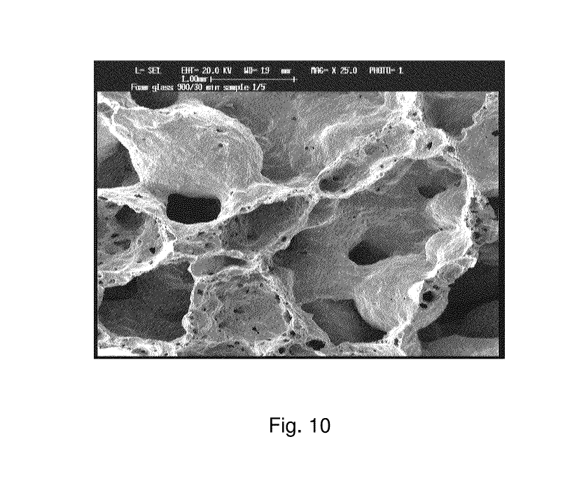

FIG. 9 is a scanning electron microscope (SEM) image of the damaged microstructure of foam glass obtained by using waste ceramic frits and glazes produced under a firing condition of 900° C. and 30 minutes of firing cycles. Increasing the firing temperature from 800° C. to 900° C. destroys the cellular structure.

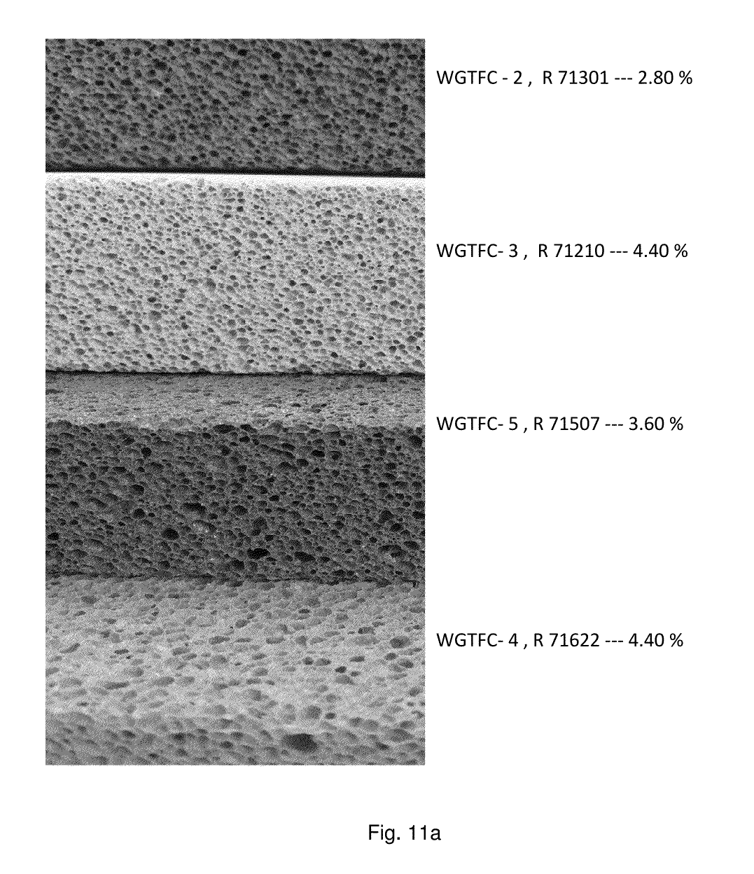

FIG. 10 is a scanning electron microscope (SEM) image of the full damaged microstructure of foam glass obtained by using waste of ceramic frits and glazes produced under a firing condition of 900° C. and 30 minutes of firing cycles. It can be seen from FIG. 10 that the microstructure of foam glass is destroyed by increasing the temperature of firing from 800 to 900° C. in that the homogeneous cellules have disappeared, the thickness of the walls of cellules has increased, the density of the foam glass increases and permeability is lost and water absorption increases.

Use of Waste Glass from Monitor and Television (CRT)

Part of the present study studied the use of recyclable cathode ray tube (CRT) glasses in the foam glass production process. CRT tubes are generally made of two to three types of glasses each having a different composition. The flat glass in the front of flat displays contains barium whereas the curved funnel shape glass at the back of the monitor typically contains lead in it. Both types can be used as starting raw materials in the present foam glass production methods.

Several tests have been carried out using alternative samples. Formulas contain flat and mix glass blended with different weight percentages of both front and funnel glasses. Table 3 shows various formulations in which the CRT front glass was used as a starting constituent along with a foaming agent and other waste glass and kaolin waste. Front glass is substituted in the formulas from about 9.35% (WGTV/1 in the left most column), to about 93.35% by weight (WTV in the second last column on the right hand side of the Table 3). The outstanding result of reducing the firing temperature from 900° C. to 825° C. was achieved. Tests were initially conducted at 900° C. and this temperature was the maximum used with the results being quite acceptable for all samples in the table. Further studies showed that the same result was achieved at lower firing temperatures at 850° C. and even 825° C., with increasing the amount of front glass content. Based on these results it is concluded that the best firing temperature with this type of glass is about 825° C. The corresponding optimum soaking time in the kiln for foam glass production was determined to be about 45 minutes.

Referring to Table 3 again, it was observed that as the percentage of front glass inclusion in the formulations increases, the pores grow gradually and their green color turns to dark green and finally dark. Specifically, when the percentage of front glass exceeds 46.67% by weight in the compositions WGTV/3, WGTV/4 and WTV (with WTV only having front glass inclusion in the composition), the resulting foam glass colors are dark or black in color. An optical composition in this trial is WGTV/2 with 28% by weight using front monitor CRT glass.

Effect of Replacing Lead-Bearing Monitor Glass with Recycled Glass and the Consequent Chemical Degradations

The promising results obtained in the process of using the front monitor glass, and its profound effect on being advantageously able to lower the sintering temperature from 900° C. to 825° C., prompted further studies of using lead bearing funnel glass. In the previous examination of the front monitor glass, the best results were obtained with 28% by weight glass replacement in Table 3. Based on this, the new compositions were chosen to include samples in the range of 18% to 28% by weight of funnel glass replaced with the conventional glass. Therefore the compositions WGTVX, WGTVX/1 and WGTVX/2 in Table 4 were prepared. In general, use of funnel glass in foam production is not recommended due to presence of the element lead. However it seems that in certain circumstances lead leaching can be controlled. In fact it is possible to design the foam chemical structure such that leaching remains in the acceptable and standard region even when in contact with water and temperatures as high as 50° C. The wet process of Flow Chart 2 (direct method) and Flow Chart 4 (indirect method) for shaping and producing foam glass is not recommended when lead bearing waste glass is used in the composition of foam glassy material.

The formulation WG/2 in Table 3 is the standard foam glass formulation with 93.35% by weight of recycled glass. This formulation provides the most suitable foam when fired at 900° C. with a soaking time of 45 to 60 minutes. It is therefore chosen as a base model for replacement and comparison purposes.

### Use of Blast Furnace Slag in Foam Production

The results of experiments show that direct inclusion of blast furnace slag, ceramic and porcelain body and their glaze waste, debris of cement, concrete and bricks in foam glass production is not possible. This is because of non or partially glassy nature of these materials which limit their direct application in producing foam glass. In consequence even the presence of very small amount, that is an 8% by weight, can ruin the cellular structure of the foam and lead to disappointing outcomes. On the other hand the direct application of slag in foam glass production is not favorable for not able to act as a foaming agent too.

Slag was studied as a constituent in foam glass formulations. Table 6 shows formulations with small amounts of slag directly included in the starting formulations labeled WGS, WGS/1, WGS/2 and WGS/3. A foaming agent was including in the formulations and the direct method using both wet and dry according to the methods of Flow Charts 1 and 2 was used to attempt to prepare the foam glass. Table 7 shows formulations with significantly higher amounts of slag (compared to formulations of Table 6) directly included in the starting formulations labeled SF, WGSF, WGS WGSF*, WGSF*/1,WGSF/1 and WGS/1. A foaming agent was including in the formulations and the direct method using both wet and dry according to Flow Charts 1 and 2 was used to attempt to prepare the foam glass. None of the formulations of Tables 6 and 7 converted to foam glass after firing under different conditions even in the presence of a foaming agent.

However, the inventors have discovered that by fritting the slag first in accordance with fritting steps 50 in Flow Charts 3 and 4 in the presence of the MF frit, then mixing this fritted constituent with the rest of the starting products resulted in good quality foam glassy materials. The MF frit, whose chemical formula is given in Table 5 is a useful agent to be fritted along with the slag in process 50. A combination of MF frit fritted along with slag in Table 9 provides a suitable foam ingredient. In Table 8, results for several compositions are shown.

The results obtained show that foam glass will only be produced if the formulas such as the SMF composition is first fritted and then used as a raw material in a certain compositions shown in Table 8. Another very important finding in this disclosure relates to the foaming property of this new frit (SMF). Using this frit in the composition of foam will generate the cellular structure in foam glass without foaming agent addition. From above experiments we found out that the best option for quality foam with suitable color and density is the formula, which contains about 45 to about 65% by weight. of SMF frit and 25% wt to about 45% by weight of MF flux frit (see columns SMF*/2, SMF*/3 and SMF*/4 in Table 8). The optimum firing temperature is at about 825° C. for about 30 minutes.

### Use of Cements and Construction Refuse (Reclaimed Concrete and Bricks) in Foam Production

Similar to slag, concrete wastes have also been used in both the wet and dry foam glass production processes disclosed herein. The starting materials, shown in Table 9, are fritted together at 1400° C. (Frit MFCEM) with a low melting frit such as MF (using process steps 50 in Flow Charts 3 and 4). The frit MFCEM is a compound, which is employed in foam production. For example, in Table 10 the foam composition which uses a mixture of SMF (fritted Slag+MF), and MFCEM frit shown in Table 9 without any foaming agent present is shown. The result is a good quality foam glass exhibiting no water absorption. The surface is covered with tiny pores and enhances the very advantageous hydrophobic properties beneficial to the foam glass, particularly when used in external applications.

Use of Wastes Obtained from Clay Washing Plants

By partial substitution of some of the glassy material in the foam composition with clay or kaolin (K-31) up to 15% by weight it was observed that this was advantageous since in addition to improving the viscosity of the melt during firing process, it also increases the foamability in the vertical direction. However higher levels of the clay above 15% by weight content resulted in the inability to produce foam glass.

More specifically, Table 11 shows that foam glass was produced when the clay content was gradually increased from 5% to 15% by weight and fired at 900° C. for 45 minutes using the processes of both Flow Charts 1 and 2. The increase in kaolin content caused the density of the resulting foam glass to rise, resulting in an increase in the height of the product instead of an increase in the area. Another outcome is production of foam glass with softer and finer pores. However, addition of more than 15% by weight of the clay material (kaolin) was observed to be detrimental and destroy the glassy structure of the foam such that no foam glass could be attained. For example, none of the compositions in Table 12 could be processed to produce foam glass when fired at 900° C. for 45 minutes using the processes of both Flow Charts 1 and 2, the same conditions used in Table 11 using the smaller amounts of K-31.

### EXAMPLES

### The Use of SiC as a Foaming Agent at Temperatures from 800° c to 900° C.

In comparison to other foaming agent materials, SiC exhibits a superior foaming capability which makes it one of the most suitable constituents in current foam glass production. While it is also a good foaming agent in the processes disclosed herein in which other non glass constituents, such as ceramic frits and glazes are mixed with the usual glass starting materials, in view of the high cost of SiC it is desirable from an economic point of view try to reduce the amount of SiC used for foam glass production. The inventors have carried out studies in order to determine the foaming capabilities and the end product characteristics foam glass using different amounts of SiC in a temperature range of 800 to 900° C., undergoing a 30 minute heating cycle.

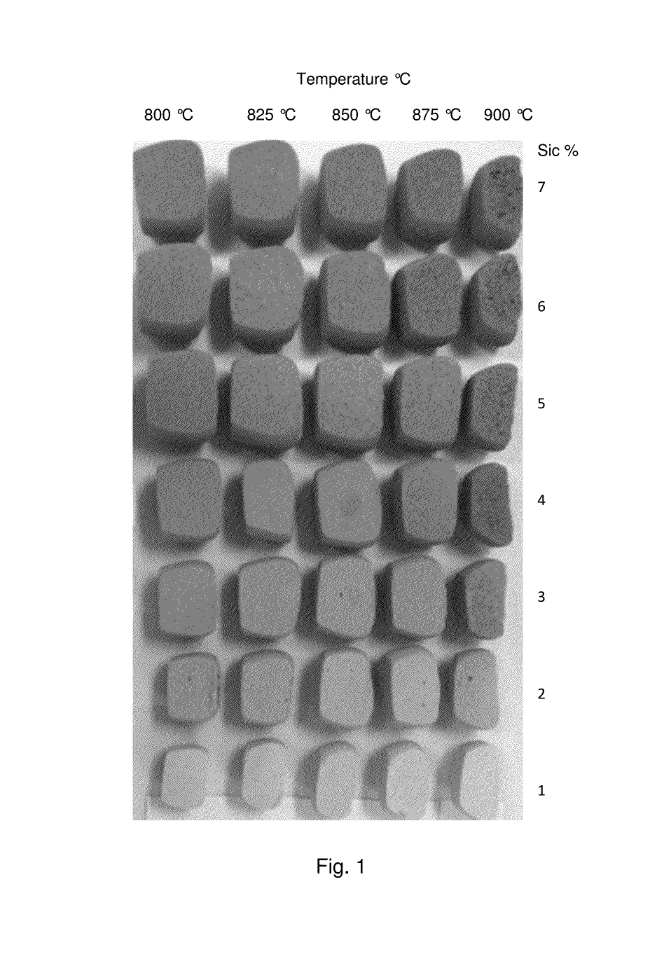

FIG. 1 are optical photographs of foam glass structures produced by using ceramic waste frits and glazes of increasing SiC % by weight content, (shown on the right hand side and increasing from the bottom to the top of the figure), and for increasing firing temperature from 800° C. to 900° C. from left to right at the top of the figure, which shows the development of foam structure.

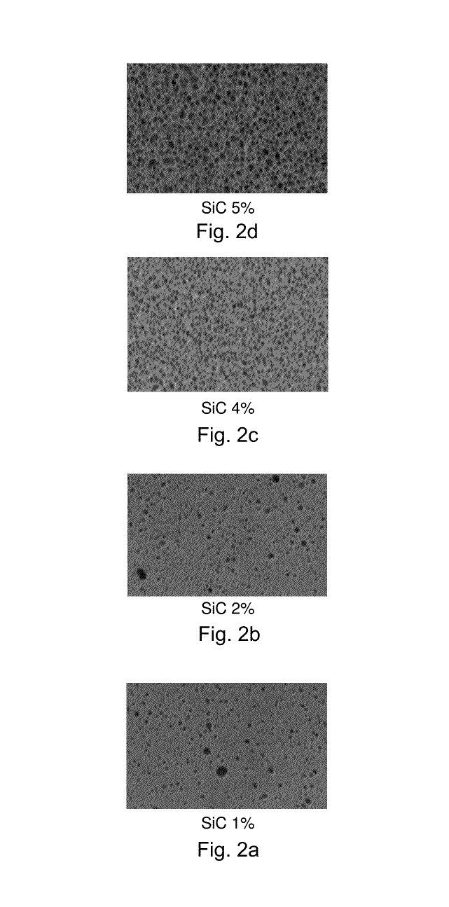

FIGS. 2a) to 2d) show optical photographs of foam glass structures produced by using ceramic waste frits and glazes of increasing SiC content from 1% to 5% by weight and at a constant temperature of 850° C.

Referring to FIGS. 1 and 2a), volumetric expansion and foam ability are low and restricted to 25% by volume for the sample with a SiC content of 1% by weight (bottom row of FIG. 1). The density is around 870 Kg/m³ and color is white and cream. Due to non uniformity in the cells dimensions, foam ability is uncontrollable.

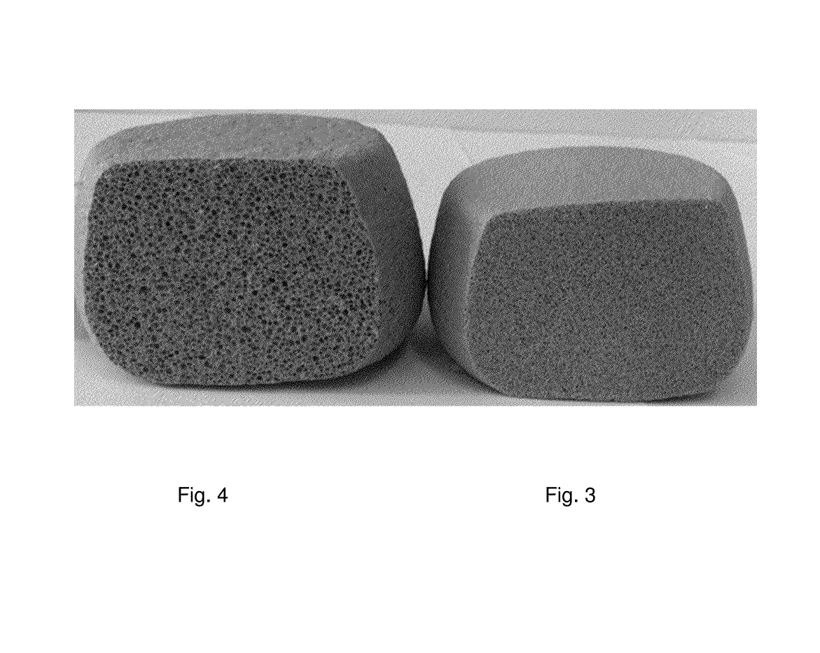

Increasing the SiC content to 2% by weight, volumetric expansion also increases to 40%, as compared to the previous case. Density reaches 570 Kg/m³ and the color turns to darker cream FIG. 1 (second row from the bottom) and FIG. 2b. As the SiC weight is raised to 3% by weight, a volume change up to 57.5% is observed and the color stays cream and the density is further reduced to 530 Kg/m³. The foam glass produced with the 4% SiC by weight content reveals that the volume expansion reaches 75%, color becomes dark cream and density lowers to gain a value of 430 Kg/m³, see FIG. 2c and FIG. 3. FIG. 3 shows an optical photograph of a foam glass structure produced by using ceramic waste frits and glazes in which the SiC content is 4% by weight and the firing temperature is 850° C.

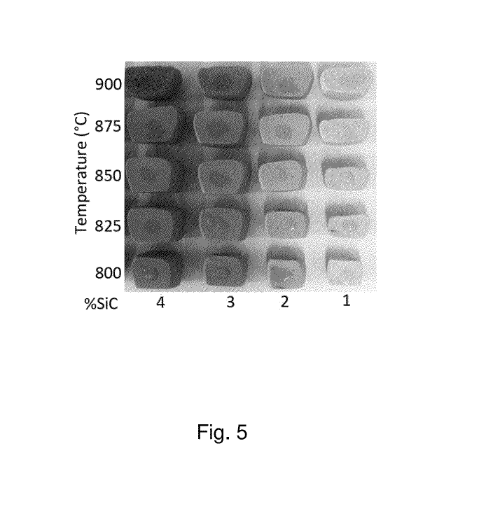

FIG. 4 shows an optical photograph of a foam glass structure produced by using ceramic waste frits and glazes in which the SiC content is 5% by weight and the firing temperature is 850° C. In this case the size of the cells are larger than the sample with 4% SiC by weight.

As seen in the FIG. 2d and FIG. 4, the sample with the 5% by weight SiC content has resulted in a volumetric expansion of 92.5%. The density is considerably reduced to 250 Kg/m³ and the color has remained dark cream. It is interesting to observe that raising the SiC content from 5% to 7% and then 10% by weight, has not resulted in any significant variation in the value of the volumetric expansion while the colors of the samples tend to become more of grey and dark grey (black).

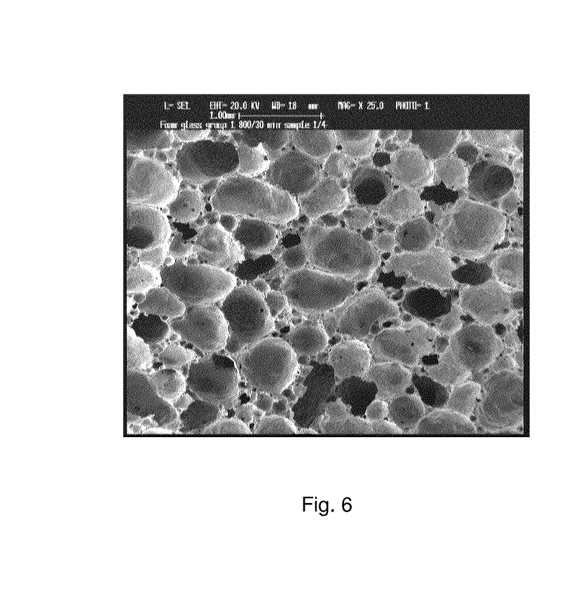

Similar results are obtained for samples tested at higher temperatures of 800 up to 900° C. Specifically, FIG. 5 shows optical photographs of various samples of foam glass produced in accordance with the present invention showing the development of foam structure and its effect on water absorption in different samples produced by using ceramic waste frits and glazes with increasing SiC % content by weight and increasing temperatures during firing. FIG. 5 shows the development of foam structure and its effect on water absorption in different samples produced by using ceramic waste frits and glazes with increasing SiC % content by weight. Increasing the temperature to 850° C. causes a uniform foam glass structure developed. Raising the temperature over 850° C. causes the deformation in microstructure.

Based on these studies, it is noted that the highest expansion and desirable foaming property, a direct consequence of homogenous cells with suitable dimensions and low density, are achieved via samples where SiC content is between 4 to 5% by weight. Considering such features as the volume expansion and uniform cell dimension, samples with 7.5 to 10% SiC by weight are quite similar to the group of samples having 4 to 5% by weight inclusion. The only difference is that the former have a darker color. The cellular structure of the foam glass produced using 4 to 5% SiC by weight are very homogenous and is deemed to contain the appropriate value for SiC content.

The SiC % content by weight in the formulation together with the firing conditions are important factors for controlling the foam glass density. For example it is possible to achieve a 300 Kg/m³ foam glass density with a 2% SiC content by weight at a firing temperature of 825° C. It is also observed that by maintaining a constant SiC content while changing the temperature from 800° C. to 900° C. at 25° C. increments, density is gradually reduced. This trend applies to all samples containing less than 5% SiC by weight. Above this value, density remains constant. A 30 minute firing cycle at 850° C. is found to be the most suitable condition for all samples. The tendency to reduction in density and increase of volume expansion with raising temperature and for all percentage values of SiC follows a similar pattern.

Provided lower values for water absorption by the foam glass are desired, foam firing should be carried out at a lower temperature of about 800° C. with about a 30 minute firing cycle. Increasing firing temperature reduces foam viscosity and amplifies gas diffusion between cellular layers. This phenomenon creates cores which facilitate cellular connectivity. The presence of such cavities accommodates water absorption to more distant internal layers.

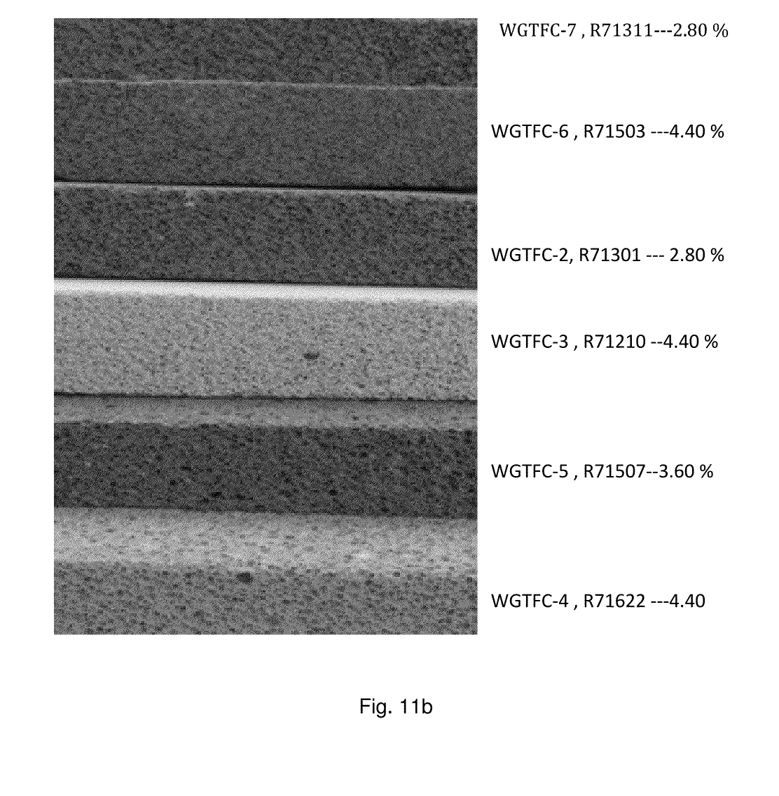

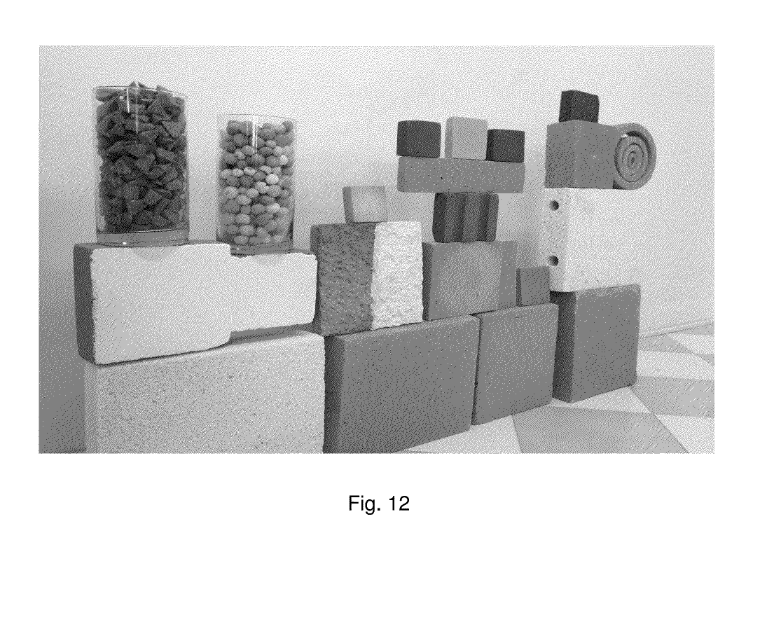

FIGS. 11a and 11b shows multicolored foam glass produced using the direct methods of Flow Charts 1 and 2 for producing using waste of ceramic frits and glazes. Table 19 provides the compositions used to produce these foam glasses. Ceramic pigments of group R71000 are added physically during mixing and grinding. Their percentage of ceramic color added as indicated in the table varies from 1.80% by weight for the most strong color of dark blue (R71203) to 4.40% by weight for the lighter colors. These foams were produced using the methods of Flow Charts 1 and 2 by addition of ceramic pigment to the principal composition. Ceramic colors pigments are weighed, added to the mixture of raw materials (Table 19) and homogenized before being transformed into the foams according to the methods shown in these Flow Charts. Beautiful color foams are produced by this method. The four (4) images shown in FIG. 11a are enlarged photographs of the first four (4) photographs starting from the bottom of the samples shown in FIG. 11b in which the cellular foam cell structures are clearly observed.

As can be seen from Table 19, 1% by weight of iron oxide was also added to the composition of all the samples to intensify the foaming properties of the foam glass. The presence of transparent frit F-38 in the composition of the foam glass increases the intensity of the color and almost all the ceramic colors used present the best shades in the foams produced even though the foaming agent (SiC) was 2% by weight.

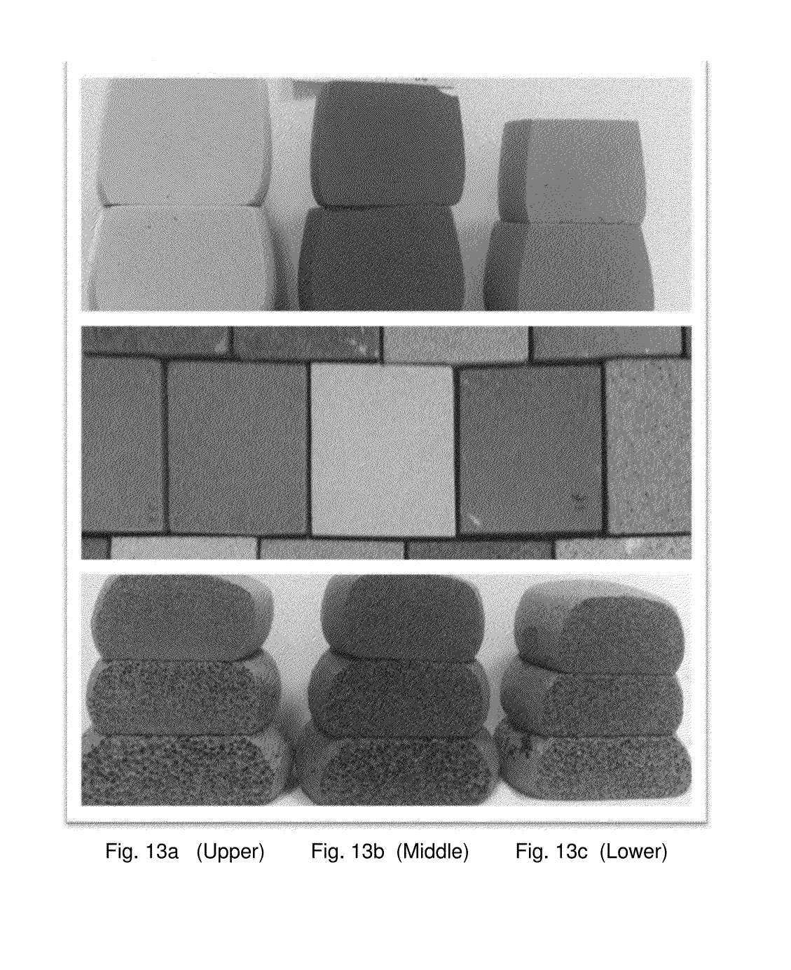

FIGS. 13a, 13b and 13c shows several different colored foam glasses produced using the methods disclosed herein. This Figure is in three parts, upper (FIG. 13a), middle (FIG. 13b) and lower (FIG. 13c) sections. The upper section shows the foams developed from slag frits (SMF) and the MF material. The chemical compositions of such frits are given in Table 9 (for SMF frit) and Table 4 (for MF frit). This category of foams have many improved properties over other conventional foams and develop very beautiful and aesthetically pleasing colors. These foams, being produced for the first time using the methods disclosed herein, are made from waste materials which are otherwise would be very harmful to the environment. A prominent feature of this category of foam glass is that no foaming agents are required. Therefore white foams can be produced which considerably reduce the color consumption. Moreover the firing conditions are remarkably improved to 800° C. for 30 minutes.

The middle section of FIG. 13b shows the colored foams generated using the formulations of Table 19 using both wet and dry methods of Flow Charts 1 and 2. The presence of transparent frits enhances the color quality in these foams such that all colors including red are well developed. While a drawback is the increased color consumption due to the presence of 2% by weight foaming agent in the composition it was observed that inclusion of 1% by weight iron oxide helps the foaming performance.

The lower section of FIG. 13c shows foams developed from recycled glass using the formulations of Table 16. This class of foams are not suitable for manufacturing of colored products due to color alterations of most colors including ceramic ones during the process. The firing temperature at 900° C. was rather high and had negative effects on the appearance of the foam glass color. Both the wet and dry methods shown in Flow Charts 1 and 2 were used to produce these colored foam glasses.

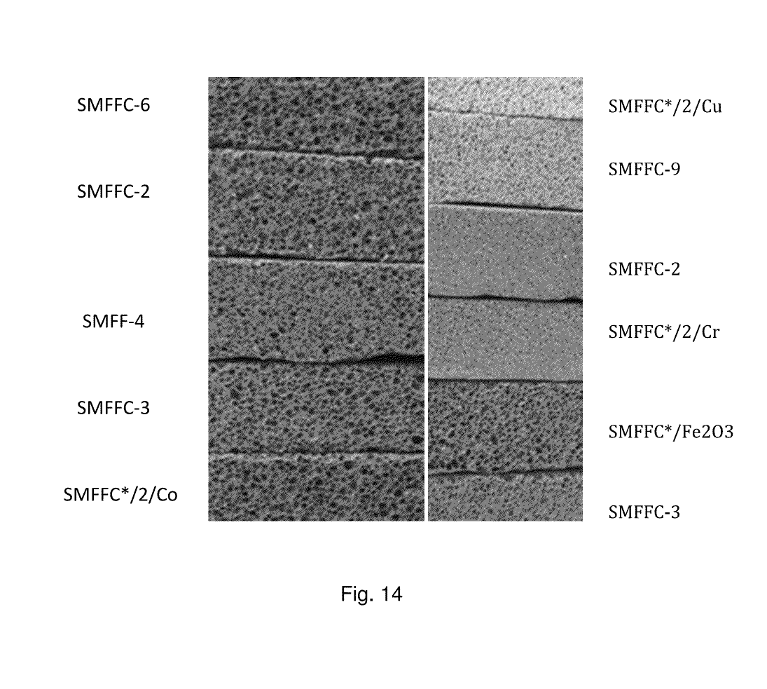

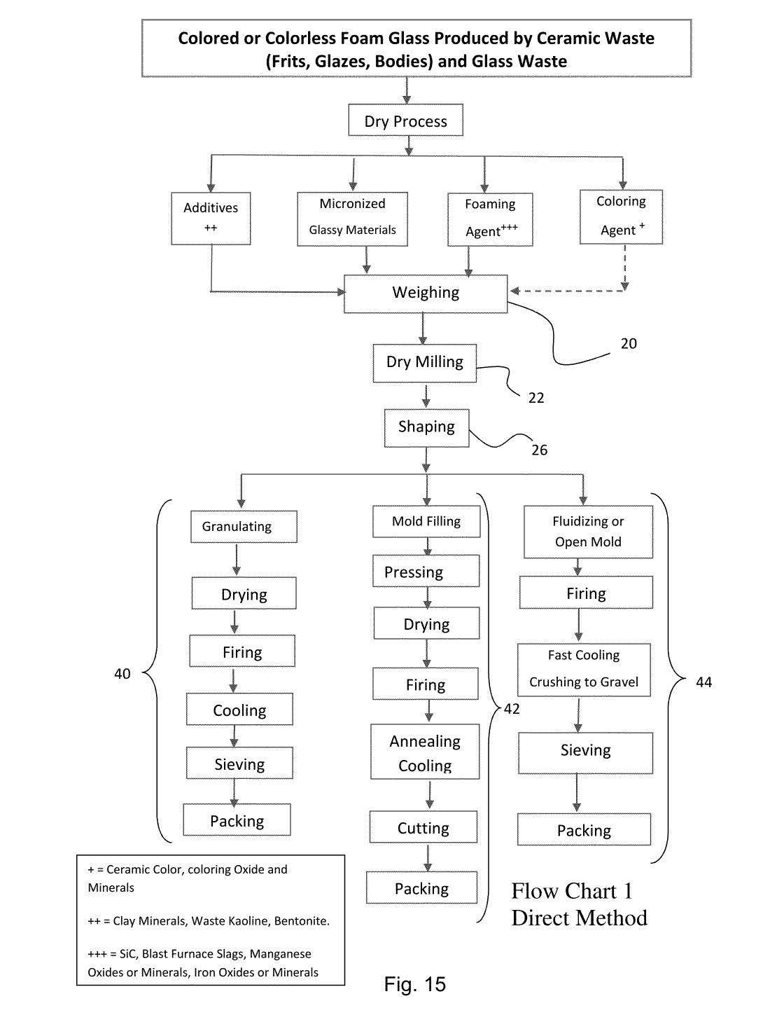

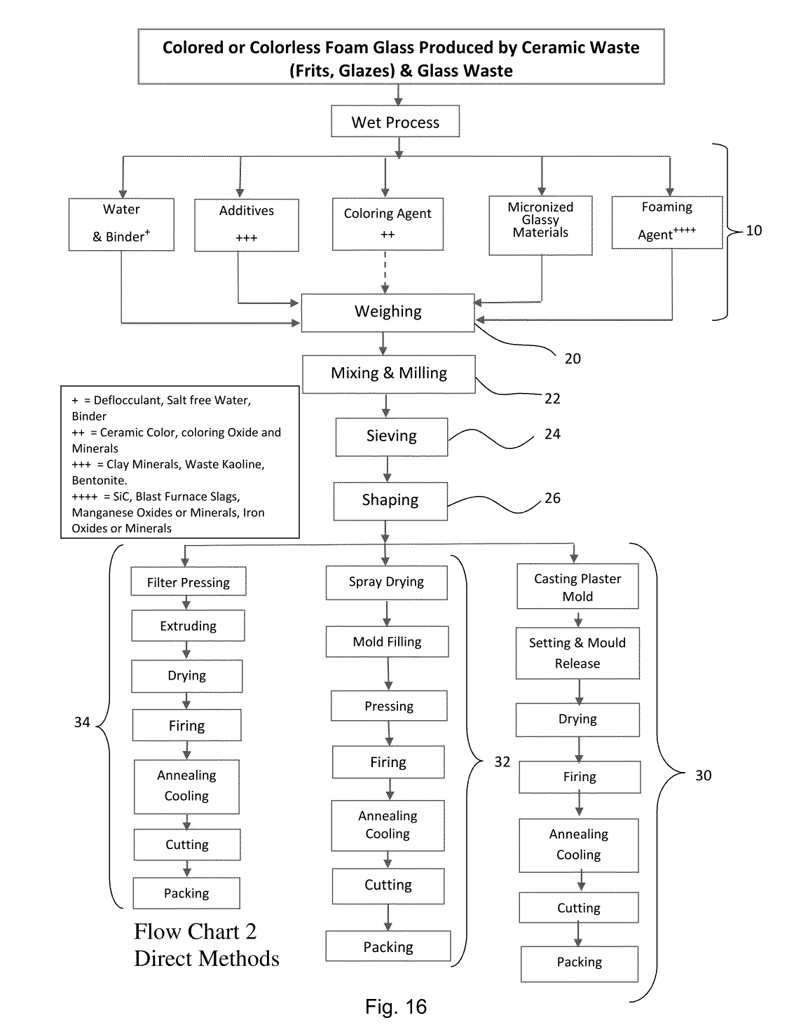

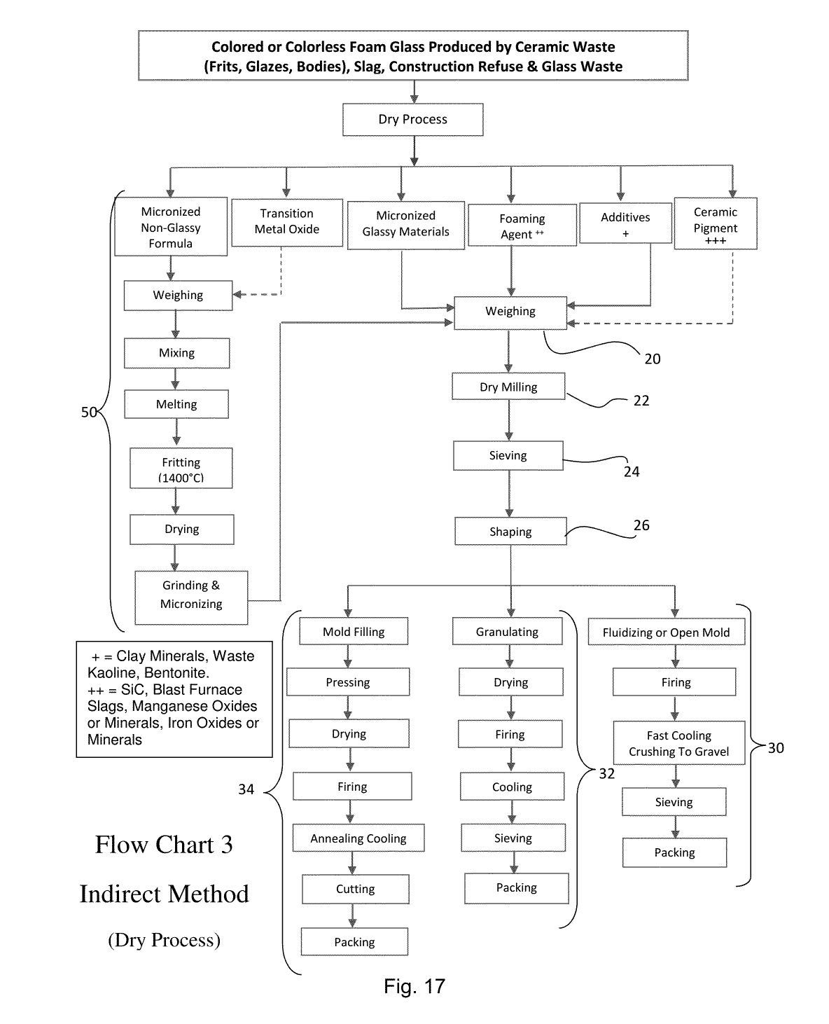

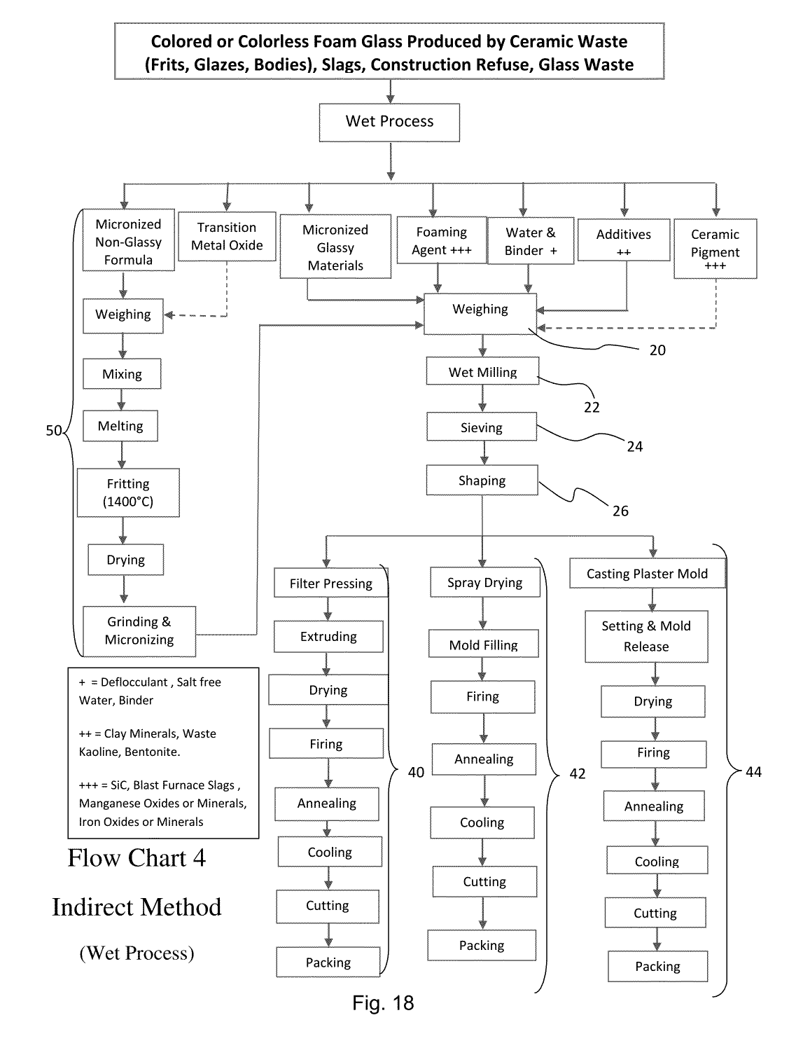

FIG. 14 shows foams made from various slag frit including SMF (Table 9), flux frit MF (Table 5), Kaolin and different ceramic pigments. Two groups of colored foam glass produced by using both direct and indirect methods using Flow Chart 1 to 4 were produced an Table 23 shows the formulas of the colored foam glass produced. No foaming agent was used and as explained earlier, in addition to aesthetically pleasing colors, these foams display exceptionally desirable physical and chemical characteristics.

### Advantages of Dry and Wet Indirect Method

An advantage of the dry and wet indirect methods disclosed herein is that by use of inorganic materials such as slag, less of the SiC foaming agent needs to be used. Since SiC is fairly expensive, use of the non glassy materials such as slag reduces the amount of SiC required. Other advantage include the fact that none of the waste and recyclable materials disclosed herein as starting materials can be used directly as starting materials until they have been melted or fritted to give the needed amorphous structure need to form the foam glass products using the indirect and direct processes.

Using relatively inexpensive metal oxides such as iron and manganese as a constituent of the glass foam provides excellent control over formation of uniform cellular in the foam glass with much smaller amounts of the very expensive SiC as the foaming agent. In addition, using the processes disclosed herein, colored foam glass can be produced much more economically by using inexpensive colored oxides instead of the much more expensive ceramic color constituents used in the known direct process.

A significant advantage of using the some of the waste or recyclable materials in the processes disclosed herein is they, once converted to a glassy material, exhibit activity as foaming agents thereby allowing less of the more expensive conventional foaming agents to be used. As noted above, the glassy materials obtained from different waste or recyclable products when used to produce the foam glass will give foam glass with different physical, mechanical and chemical properties compared to normal foam glass using just glass as a starting material. Thus the physical, mechanical and chemical properties of the final foam product can be tailored depending on the final use of the foam glass.

As a specific example, a very significant advantage of the processes disclosed herein is the ability, depending on the starting materials, to control the microstructure development and the cellular type of structure in the final foam glass, i.e. isolated cellules with separated walls or open interconnected channeled structures, each of which have different applications. The glass foams produced using the indirect method with the glass-ceramic composite can have variable or tuned physical, structural, mechanical and chemical properties depending on the type of non-glass inorganic constituent (subsequently made glassy by fritting) and the ratios of this constituent to the glassy component.

### Preparation and Production of New Colored Foam Glasses in the Presence of Coloring Oxides and Ceramic Pigments

The colored foam glasses are our new inventions with a wealth of inspiring ideas and innovative applications in building industry. In fact they can be considered as multifunctional construction elements. In addition to enjoying the superior qualities common to every other basic foam glass material such as heat and sound insulation properties and being a fire retardant material, the colored foam glasses find many other uses in the internal and external architecture of the buildings. They serve to enhance the look and improve the decoration of interior and exterior spaces. They can be used as ceiling and wall decoration panels, serve the acoustic needs and maintain a more pleasant room atmosphere during hot summer or cold winter days.

As shown in Flow Charts 1 to 4, colored foams can be produced in two different ways using either the direct or indirect processes. In the direct wet and dry methods shown in Flow Charts 1 and 2, a ceramic color pigment (stain) is physically added to the foam composition whereas in the indirect wet and dry methods shown in Flow Charts 3 and 4, only transition metal oxides are added to the glass or glaze composition during the melting process. Examples of ceramic color pigments used in the direct wet and dry methods shown in Flow Charts 1 and 2 include R71503 light brown (Cr—Fe—Zn—Al), R71507 red brown (Cr—Fe—Zn), R71311 green (Cr—Al) and dark blue (Co—Al). Examples of transition metal oxides used in the indirect methods shown in Flow Charts 3 and 4 include copper oxide (CuO), chromium oxide (Cr₂O₃), cobalt oxide (CoO), iron oxide (Fe₂O₃) and manganese oxide (MnO).

It is noted that ceramic pigments (stains) can only be used in the direct wet and dry methods shown in Flow Charts 1 and 2 and the transition metal oxides cannot be used in these process but can be used in the methods of Flow Charts 3 and 4. The reason for this is using ceramic pigments in the melting/fritting step shown at process steps 50 in Flow Charts 3 and 4 is not feasible, while on the other hand metal oxides may be used in this melting/fritting step. This is because the crystalline structure of ceramic pigments is destroyed and decomposed during the melting process.

As noted above the coloring agents for use in the indirect methods of Flow Charts 3 and 4 are transition metal oxides or other metal based compounds In this case oxides of metals such as, but not limited to, copper, chromium, cobalt, iron, manganese, selenium and other compound like gold chloride and sulfur are added to the composition of glass and after melting and homogenizing the color develops in the glass structure, and can produce different colors depending to the state of oxidation or reduction of the metal oxide in the melt. For example, if the oxidation state of copper is zero (i.e., in the metallic state (Cu) in glass) it will then produce a foam glass with a red ruby color and if it is in the +2 valence (i.e., CuO), it will produce blue colored foam glass.

As noted above, a significant advantage of using metal oxide coloring agents in the indirect processes of Flow Charts 3 and 4 is that using small quantities of metal oxide obviates the need for using SiC foaming agents.

The physical inclusion of ceramic pigments in the glaze compositions yields colored foam glass with excellent quality. Therefore it can be concluded that presence of ceramic frits or glazes in the foam compositions helps to enhance the color quality of the final foam. Studies show that using transparent frits increase the color intensity and produces darker colored foam glass whereas opaque frits have the opposite effect and result in foam glass with light pastel colors. In order to determine the amount of the color requirement and for the sake of comparison, various foam compositions with and without ceramic frits (opaque and trans) have been produced. In this part of the work foam glass compositions from the above results which exhibited the best foaming properties have been used. The criteria has been the maximum use of recycled glasses from flat screens, clear glass bottles and waste ceramic frits (opaque, namely 3-655/2 and transparent namely F-38) in the production of the foam glasses. Table 5 shows the oxide composition (wt %) of these ceramic frits.

Table 13 shows the characteristic (code numbers, color shade, oxide composition and density) of ceramic pigments (stains) used for producing colored foam glass by direct method Flow Charts 1 and 2.

Tables 14 and 15 show the colored foam compositions prepared in the direct wet and dry methods of Flow Charts 1 and 2 without the inclusion of ceramic frits. In Table 15 slightly less mixed glass is used compared to Table 14 and the SiC foaming agent content was 1% by weight in Table 14 and 2% by weight in Table 15, and the firing conditions were the same.

In both of these groups of colored foam glass produced in Tables 14 and 15, both the use of 1% SiC by weight in foams of Table 14 and 2% SiC by weight results in foams of Table 15 yielded acceptable colored foams. The color shades were not very sharp and the amount of pigment used should be more than standard to obtain the required shades. In addition the time and firing temperature is higher than normal (900° C. and 60 min).

The foams produced as shown in Table 16 used a mixture of flat waste glass and waste mix glass containers. Higher quality colored foam glass are produced in some cases as stipulated across the bottom of the Table using the firing conditions used in Tables 14 and 15. No frits were used.

It is noted from Tables 14, 15 and 16 that form glass foams made only from recycled glass, certain ceramic colors are not suitable for production of colored foam glass. In some formulations the pigment presence may reduce or increase the foaming effect, reduce or change or cause a loss of colors, change the physical and mechanical characteristics of the resulting foam glass, increase or decrease the firing conditions, and change or degrade the cellular microstructure.

In Table 17, green foam compositions are shown in which only green ceramic pigments are used. One way to avoid such problems is to use the minimum amount of the color. The green ceramic pigment (R71311) was made using chromium oxide. Ceramic pigments are the product of calcination of homogeneous mixture of different compounds in which transition metal oxides and other color producing elements are part of the compositions. The elements producing colors are stabilized in a certain crystal structures after calcination. Their states of oxidation, and their color do not change when they are physically mixed and placed in direct contact with the frits or glassy materials even at high temperature such as 1200° C. The calcination temperatures used to required to metal oxides with the desired crystal structure is normally between 900° C. and 1400° C. depending on the color and materials used.

The foam samples in which flat glass is gradually replaced by the container glass, up to 27% (WGC-20) by weight demonstrate a constant green quality with suitable foaming conditions. As the substitution process continues to upper values, the foam ability properties decrease which eventually destroys the foam color and internal structure (WGC-22). Foaming properties will recover when some of the glass in the formulation is replaced by waste ceramic transparent frits (WGTC-1 to WGTC-4). In addition the firing time reduces to 30 minute.

The colored foams using the compositions and processes of Tables 9, 17 and 18 show that the inclusion of waste ceramic frits such as the transparent F-38 (Table 17), opaque 3-655/2 (Table 18), flux frit MF (Table 18), slag frits such as SFM (Table 9) and recycled CRT flat glass group are very suitable for the production of colored foam glass. This is due to the fact that these materials have lower softening points and lower viscosity as compared to ordinary glass. Additionally a 2% SiC by weight amount of foaming agent for foam glass in both Tables 17 and 18 were observed to help preserve the sharp colors in the final foam.

Table 19 shows compositions used in the production of colored foam glass made from a mixture of flat glass, transparent frit F-38 and flux MF frits. All the compositions shown in Table 19 produced excellent colored foam glass without decreasing the color shade and intensity.

Referring to Table 20, using waste glass and waste flat CRT glasses from TV monitors results in colored foam glass with good color quality and reduced the firing temperatures (850° C.), thus resulting in considerable energy savings in production of the foam glass.

Foam compositions produced using front monitor glass and television glass containing 20% by weight barium and strontium oxides showed good results. The presence of barium oxide helps to enhance the color quality and gives foams with very attractive and brighter colors and advantageously the firing temperature is reduced to 850° C. and firing time is shortened to less than 30 minutes or less. The use of recycled TV and monitor glasses in color foam glass production is highly recommended because of the advantages mentioned above.

The direct use of various metallic transition metal oxides of chromium, cobalt, copper, iron and manganese as coloring agents for this group using the methods of Flow Charts 1 and 2 do not result in foam glass with desirable physical and chemical properties in the finished product. However they can be used using the indirect melt methods as shown in Flow Charts 3 and 4. As seen in Table 21, different compositions were formulated using copper, cobalt, manganese and chrome oxides. The colored frits were produced according to Flow Charts 3 and 4 (indirect wet and dry methods). As noted above in the discussion of the processes of Flow Charts 3 and 4, using these processes reduces the need of a foaming agent per se. The redox (Reduction-Oxidation) system present in the metal oxides in the glass frit upon melting gives rise to the foaming property of the foam glass.

Table 22 shows color conveying frits developed and shown in Table 21 are used for the production of color foam glass using indirect method (Flow Charts 3 and 4). It is noted that the best color results are related to compositions having copper oxide and the best foaming property of the compositions are those having manganese oxide as an ingredient, namely WGTV/Cu, WGTV/Cu//1 and WGTV/Mn, WGTV/Mn/1.

The compositions listed below are those shown in Table 21 from left to right and for each metal oxide the % by weight increases from left to right. WGTV/Cu*=Copper containing frit, WGTV/Cu+Kaolin K-31+SiC+SiC+Serial WGTV/Co*=Cobalt containing frit WGTV/Co+KaolinK-31+SiC+Serial WGTV/Cr*=Chromium containing frit WGTV/Cr+Kaolin K-31+SiC+Serial; WGTV/Mn*=Manganese containing frit WGTV/Mn+Kaolin, K-31+SiC+Serial

All foam glass compositions presented in Table 22 are referred to as self-color foam glass, produced by transition metal oxides of copper, chromium, cobalt and manganese inclusion and by using the indirect dry process of Flow Chart 3 and the indirect wet process of Flow Chart 4.

If the melting process is not complete or the melt mixture is not properly homogenized may affect the chemical and physical properties. The melt glass is completely homogenized and discharged before the colored foam glass is produced using the processes of Flow Charts 3 and 4. This type of foam glass is referred to as self colored. It is noted that this method of producing these self colored foams method is not suitable for producing some colors, however an advantage of this method is that it is less costly in comparison to the direct methods of Flow Charts 1 and 2.

The inventors have discovered that by using the SMF and SMF*materials, which are produced by melting the mixture of furnace slag with MF frit (according to the indirect processes shown in Flow Chart 3 and 4), for production of colored foam glass gives colored foam glasses that very advantageously exhibited both very low density (150 to 200 Kg/m³) and also very low thermal conductivity of 0.040 to 0.065 watts per meter Kelvin (W/(mK). Table 23 presents different color compositions of this range of foam products. It is noted that these colored foams were produced using a lower temperature (800° C.) as compared to foams with glass constituents, which makes them environmental friendly products which can be produced with lower energy costs. Furthermore, as the colored foam glass produced using the process of Flow Charts 3 and 4 do not require any foaming agent for their formation, the quality of the finished colored foam is considerably increased. This characteristic creates color foam glass with very aesthetically appealing colors. All the compositions in Table 23 produced excellent colored foam glass.

Table 24 shows the broad range of materials, and firing conditions used for all color and colorless foam glasses produced according to the direct methods of Flow Charts 1 and 2, and the indirect methods of Flow charts 3 and 4.

Thus, the present disclosure makes it possible to use typically non-useful ceramic waste and recyclable materials to produce very useful foam glass materials with wide ranging physical, structural, mechanical and chemical properties which may be used in different industrial sectors such as agriculture, civil engineering by converting them to glassy materials using the indirect process disclosed herein to convert them to a glassy structure.

Foam glass is typically produced from only glass and recycled glass and has been known since the 1930s produced by Corning Pittsburg in U.S.A. In the present disclosure, foam glass is produced from starting materials which have similar structure and properties to glass, including different types of recycled glass, ceramic frits and glazes and also other materials other than glass which do not have a glassy structure to start with. These materials are first melted or fritted to produce an amorphous glass structure which can then be mixed with normal glassy starting materials and the foam glass composition is produced. The new wet and dry indirect process and the wet direct process disclosed herein using multiple starting materials opens the door to production of glass foams with tunable physical, structural, mechanical and chemical properties which can be produced in very simply and economically feasible processes.

The foam glassy materials produced using the processes and starting materials disclosed herein with tunable properties have many wide ranging applications, including but not limited to, many civil engineering applications such as new building materials, road and pavement filler, agricultural applications, decorative building applications to mention just a few possible applications.

TABLE 1

| | WO | WT | WO/1 | WT/1 | WTOF | WTO | WTO/1 | WTOF/1 | WTF | WOF |
|---|---|---|---|---|---|---|---|---|---|---|
| F-38 | — | 98.50 | — | 88.70 | 39.45 | 49.25 | 44.35 | 34.55 | 69.10 | — |
| Frit % wt | | | | | | | | | | |
| 3-655/2 | 98.50 | — | 88.70 | | 39.45 | 49.25 | 44.35 | 34.55 | — | 69.10 |
| Frit % wt | | | | | | | | | | |
| MF Frit | — | — | — | — | 9.80 | — | — | 19.60 | 19.60 | 19.60 |
| % wt | | | | | | | | | | |
| SiC | 1.5 | 1.5 | 1.5 | 1.5 | 1.5 | 1.5 | 1.5 | 1.5 | 1.5 | 1.5 |
| Foaming | | | | | | | | | | |
| agent | | | | | | | | | | |
| % wt | | | | | | | | | | |
| K-31 | — | — | 9.80 | 9.80 | 9.80 | — | 9.80 | 9.80 | 9.80 | 9.80 |
| % wt | | | | | | | | | | |
| Temp. | 850 | 850 | 850 | 850 | 850 | 850 | 850 | 850 | 850 | 850 |
| ° C. | | | | | | | | | | |
| Time | 30 | 30 | 30 | 30 | 30 | 30 | 30 | 30 | 30 | 30 |
| min. | | | | | | | | | | |
| Flow | 1 & 2 | 1 & 2 | 1 & 2 | 1 & 2 | 1 & 2 | 1 & 2 | 1 & 2 | 1 & 2 | 1 & 2 | 1 & 2 |
| chart No. | | | | | | | | | | |
| Result | Foam | Foam | Foam | Foam | Foam | Foam | Foam | Foam | Foam | Foam |
| | Produced | Produced | Produced | Produced | Produced | Produced | Produced | Produced | Produced | Produced |

Increasing time over 30 minutes and temperature over 850° C. produces foam glass with cellules of bigger sizes and over 900° C. destroy the cellular structure.
F-38: Waste Transparent Frit
3-655/2: Waste Opaque Frit
MF: Flux Frit
K-31: Waste Kaolin
WO: Foam glass produced from only opaque frit + Foaming agent. + Serial number
WT: Foam glass produced from only transparent frit. + Foaming agent + Serial number
WO/1: Foam glass produced from opaque frit + K-31 + foaming agent
WT/1: Foam glass produced from transparent frit + K-31 + Foaming agent
WTOF: Foam glass produced from transparent frit + opaque frit + MF + k-31 + Foam agent + Serial number
WTO: Foam glass produced from transparent frit + opaque frit + Foaming agent + Serial number
WTO/1: Foam glass produced from transparent frit + opaque frit + K-31 + Foaming agent
WTOF/1: Foam glass produced from transparent frit + opaque frit + MF + K-31 + Foaming agent
WTF: Foam glass produced from transparent frit + MF + K-31 + Foaming agent
WOF: Foam glass produced from opaque frit + MF + K-31 + Foaming agent
Represents results for foam glass formation in formulas containing waste of ceramic frits using direct method - wet or dry (Flow Charts 1 and 2)

TABLE 2

| | WGTF | WGTF/1 | WGT | WGF | WGOF | WGOF/1 | WGO | WG/1 | WG |
|---|---|---|---|---|---|---|---|---|---|
| Waste | 39.2 | 29.40 | 29.40 | 29.40 | 39.20 | 29.40 | 29.40 | 24.50 | 0.0 |
| Mix | | | | | | | | | |
| Glass | | | | | | | | | |
| % wt | | | | | | | | | |
| Waste | 44.10 | 44.10 | 44.10 | 44.10 | 44.10 | 44.10 | 44.10 | 68.60 | 93.10 |
| Flat | | | | | | | | | |
| Glasst | | | | | | | | | |
| % wt | | | | | | | | | |
| F-38 | 4.90 | 9.80 | 19.60 | — | — | — | — | — | — |
| % wt | | | | | | | | | |
| 3-655/2 | — | — | — | — | 4.90 | 9.80 | 19.60 | — | — |
| % wt | | | | | | | | | |
| K-31 | 4.90 | 4.90 | 4.90 | 4.90 | 4.90 | 4.90 | 4.90 | 4.90 | 4.90 |
| % wt | | | | | | | | | |
| Foaming | 2.00 | 2.00 | 2.00 | 2.00 | 2.00 | 2.00 | 2.00.00 | 2.00 | 2.00 |
| agent | | | | | | | | | |
| % wt | | | | | | | | | |
| MF | 4.90 | 9.80 | — | 19.60 | 4.90 | 9.80 | — | — | — |
| % wt | | | | | | | | | |
| Temp. | 900 | 900 | 900 | 900 | 900 | 900 | 900 | 900 | 900 |
| ° C. | | | | | | | | | |
| Time | 45 | 45 | 45 | 45 | 45 | 45 | 45 | 45 | 45 |
| min. | | | | | | | | | |
| Flow | 1 & 2 | 1 & 2 | 1 & 2 | 1 & 2 | 1 & 2 | 1 & 2 | 1 & 2 | 1 & 2 | 1 & 2 |
| chart | | | | | | | | | |
| No. | | | | | | | | | |
| Result | Foam | Foam | Foam | Foam | Foam | Foam | Foam | Foam | Foam |
| | produced | produced | produced | produced | produced | produced | produced | produced | produced |

Higher firing temperature (900° C.)° and time (45 min.) is necessary to produce foam glass of similar cellular structure when the glass content is high in foam glass formulation.
WGTF: Waste Glass + Transparent frit + MF + K-31 + Foaming agent + Serial Number
WGF: Waste Glass + MF + K-31 + Foaming agent
WGOF: Waste Glass + Opaque Frit + MF + K-31 + Foaming agent + Serial number
WGO: Waste Glass + Opaque frit + K-31 + Foaming agent
WG Waste Glass (Mixed + Flat) + k-31 + Foaming agent + Serial number
Represents formulas where recycled glass and frit wastes are used simultaneously (Direct method - wet or dry, Flow Charts 1 and 2)

TABLE 3

| | WGTV | WGTV/1 | WGTV/2 | WGTV/3 | WGTV/4 | WTV | WG/2 |
|---|---|---|---|---|---|---|---|
| Waste mix | 84.00 | 74.60 | 65.35 | 46.67 | 18.70 | — | 93.35 |
| glass | | | | | | | |
| % wt | | | | | | | |
| CRT front | 9.35 | 18.70 | 28.00 | 46.67 | 74.65 | 93.35 | — |
| glass (TV) | | | | | | | |
| % wt | | | | | | | |
| K-31 | 4.65 | 4.65 | 4.65 | 4.65 | 4.65 | 4.65 | 4.65 |
| % wt | | | | | | | |
| Foaming | 2.00 | 2.00 | 2.00 | 2.00 | 2.00 | 2.00 | 2.00 |
| agent | | | | | | | |
| % wt | | | | | | | |
| Temp. ° C. | 850 | 850 | 825 | 825 | 825 | 825 | 900 |
| Time min. | 45 | 45 | 45 | 45 | 45 | 45 | 45 |
| Flow chart | 1 & 2 | 1 & 2 | 1 & 2 | 1 & 2 | 1 & 2 | 1 & 2 | 1 & 2 |
| No. | | | | | | | |
| Result | Foam | Foam | Foam | Foam | Foam | Foam | Foam |
| | produced | produced | produced | produced | produced | produced | produced |

Replacing recycle waste glass by front CRT glass do not reduce the firing time but the firing temperature of foam glass production is reduced to 825° C. with increasing the percentage of front glass to 28% by weight.
WGTV: Waste Glass + CRT Front Part (TV or monitor) + K-31 + Foaming agent + Serial number
WTV: Waste CRT Front Part (TV) + K-31 + Foaming agent
Represents foam glass formulas obtained from recycled glass and front CRT waste glass. (Direct method - Dry or wet method, Flow chart 1 and 2)

TABLE 4

| | WGTVX | WGTVX/1 | WGTVX/2 |
|---|---|---|---|
| Waste glass % wt | 74.65 | 70.00 | 65.35 |
| Funnel CRT glass | 18.70 | 23.35 | 28.00 |
| (TVX) % wt | | | |
| K-31 % wt | 4.65 | 4.65 | 4.65 |
| Foaming agent % wt | 2.00 | 2.00 | 2.00 |
| Temp. ° C. | 850 | 850 | 850 |
| Time min. | 30 | 30 | 30 |
| Flow chart No. | 1 & 2 | 1 & 2 | 1 & 2 |
| Result | Foam produced | Foam produced | Foam produced |

Replacing recycle waste glass by high lead bearing funnel CRT glass reduces rapidly the firing time and temperature of the foam glass production. The firing temperature for sample WGTVX/2 in which the funnel glass content is 28% by weight is reduced to 800 C.
Represents foam glass formulas containing funnel CRT waste glass. (Direct wet or dry method, Flow Chart 1 and 2)
WGTVX: Waste glass + Funnel CRT glass (TVX) + K-31 + Foaming agent + Serial number

TABLE 5

| | | | | Waste | Waste | |
|---|---|---|---|---|---|---|
| | | | | transparent | opaque | |
| | mix | flat | Borosilicate | F-38 | 3-655/2 | |
| | glass | glass | E-glass | frit | frit | MF frit |
| Oxide | Wt % | Wt % | Wt % | Wt % | Wt % | Wt % |
| SiO2 | 74.20 | 73.00 | 55.52 | 58.77 | 56.10 | 5.00 |
| Al2O3 | 1.24 | 0.14 | 14.51 | 10.56 | 6.32 | 0.00 |
| B2O3 | 0.00 | 0.00 | 6.90 | 13.97 | 11.28 | 44.35 |
| Na2O | 13.30 | 13.80 | 0.62 | 4.20 | 5.05 | 0.00 |
| K2O | 0.29 | 0.03 | 0.00 | 2.88 | 1.71 | 0.00 |
| CaO | 10.50 | 8.75 | 17.86 | 3.73 | 5.64 | 31.00 |
| ZnO | 0.00 | 0.00 | 0.00 | 2.65 | 4.37 | 0.00 |
| BaO | 0.00 | 0.00 | 0.00 | 2.95 | 0.00 | 0.00 |
| MgO | 0.20 | 3.77 | 4.25 | 0.25 | 0.24 | 19.60 |
| Fe2O3 | 0.05 | 0.50 | 0.34 | 0.02 | 0.02 | 0.05 |
| TiO2 | 0.01 | 0.01 | 0.00 | 0.02 | 0.02 | 0.00 |
| SO3 | 0.21 | 0.00 | 0.00 | 0.00 | 0.00 | 0.00 |
| ZrO2 | 0.00 | 0.00 | 0.00 | 0.00 | 9.25 | 0.00 |

Chemical analysis of mix glass, flat glass, borosilicate E-glass, transparent F-38 frit, opaque 3-655/2 frit and MF flux frit.

TABLE 6

| | WGS | WGS/1 | WGSMF | WGSMF/1 |
|---|---|---|---|---|
| Waste glass | 78.00 | 70.00 | 35.00 | 63.00 |
| (Flat) % wt | | | | |
| Slag % wt | 8.00 | 16.00 | 12.00 | 8.00 |
| SMF % wt | 0.00 | 0.00 | 45.00 | 15.00 |
| K-31 % wt | 12.00 | 12.00 | 6.00 | 12.00 |
| Foaming Agent | 2.00 | 2.00 | 2.00 | 2.00 |
| % wt | | | | |
| Temp. ° C. | 900 | 900 | 900 | 900 |
| Time min. | 45 | 45 | 45 | 45 |
| Flow chart No. | 1 & 2 | 1 & 2 | 1 & 2 | 1 & 2 |
| Results | No foam | No foam | No foam | No foam |
| | produced | produced | produced | produced |

Direct use of slag does not generate foam even accompanied by foaming agent, glass material and SMF frit.
WGS: Waste Glass + Slag + K-31 + Foaming agent + Serial number
WGSMF: Waste glass + Slag + SMF + K-31 + Foaming agent + Serial number
SMF: Frit produced from melting Slag + MF (Fritted Material)
Direct inclusion of small quantity blast furnace slag in production of first category foam glass, including WGS, WGS/1, WGSMF and WGSMF/1. Foaming agent is present in foam glass formula.
Direct method, wet or dry - (Flow Charts 1 and 2) was used.

TABLE 7

| | SF | WGSF | WGS | WGSF* | WGSF*/1 | WGSF/1 | WGS/1 |
|---|---|---|---|---|---|---|---|
| Slag % wt | 40.00 | 31.00 | 40.00 | 40.00 | 51.00 | 45.00 | 45.00 |
| MF % wt | 50.00 | 39.00 | — | 25.00 | 21.00 | 10.00 | — |
| K-31 % wt | 10.00 | — | 10.00 | 10.00 | 7.00 | — | 5.00 |
| Waste mix | — | 30.00 | 50.00 | 25.00 | — | — | — |
| glass % wt | | | | | | | |
| Waste flat | — | — | — | — | 21.00 | 45.00 | 45.00 |
| glass % wt | | | | | | | |
| TubeWaste | — | — | — | — | — | — | 5.00 |
| % wt | | | | | | | |
| Temp. ° C. | 900 | 900 | 900 | 900 | 900 | 900 | 900 |
| Time min. | 45 | 45 | 45 | 45 | 45 | 45 | 45 |
| Flow chart | 1 & 2 | 1 & 2 | 1 & 2 | 1 & 2 | 1 & 2 | 1 & 2 | 1 & 2 |
| No. | | | | | | | |
| Results | No foam | No foam | No foam | No foam | No foam | No foam | No foam |
| | produced | produced | produced | produced | produced | produced | produced |

Direct use of slag does not generate foam even accompanied by MF frit and glass materials.
SF: Slag + MF + K-31
WGSF: Waste glass + Slag + MF + Serial number
WGSF*: Waste glass + Slag + MF + K-31 + Serial number
WGS: Waste Glass + Slag + K-31 + Serial number
Direct inclusion of big quantity blast furnace slag in production of second category foam glass. Direct wet or dry method was used (Flow Charts 1 and 2).

TABLE 8

| | SMF* | SMF*/1 | SMF*/2 | SMF*/3 | SMF*/4 | SMF*/5 |
|---|---|---|---|---|---|---|
| SMF % wt | 35.00 | 40.00 | 45.00 | 55.00 | 65.00 | 75.00 |
| MF % wt | 55.00 | 50.00 | 45.00 | 35.00 | 25.00 | 15.00 |
| K-31 % wt | 10.00 | 10.00 | 10.00 | 10.00 | 10.00 | 10.00 |
| Foaming | 0 | 0 | 0 | 0 | 0 | 0 |
| agent % wt | | | | | | |
| Temp. ° C. | 800-825 | 800-825 | 800-825 | 800-825 | 800-825 | 800-825 |
| | 850 | 850 | 850 | 850 | 850 | 850 |
| Time min. | 30-45-60 | 30-45-60 | 30-45-60 | 30-45-60 | 30-45-60 | 30-45-60 |
| Flow chart No. | 3 & 4 | 3 & 4 | 3 & 4 | 3 & 4 | 3 & 4 | 3 & 4 |
| Result | Foam | Foam | Foam | Foam | Foam | Foam |
| | produced | produced | produced | produced | produced | produced |

The foam compositions in this table can be produced in different temperature from 800 to 850° C., with a firing time from 30 to 60 minutes. Foam is produced in all cases in the absence of foaming agent. The glass compositions shown above have a wide range of firing times and temperatures. The foams produced are all in white in color.
SMF: Frit made of (Slag 45% wt + MF 45% wt + K-31 10% wt)
SMF*: SMF + MF + K-31 + Serial number
Represents foam glass compositions containing. SMF frit prepared by indirect wet or dry method (Flow Chart 3 and 4).

TABLE 9

| Frit composition | MFCEM | SMF |
|---|---|---|
| Materials | % Wt | % Wt |
| Slag from blast furnace | 0.00 | 45.00 |
| MF frit | 45.00 | 45.00 |
| Refused cement and concrete | 45.00 | 0.00 |
| K-31 (Kaolin Waste) | 10.00 | 10.00 |

Represents the frit composition prepared using waste of cement and concrete and slag from blast furnace.
(Section 50 in flow chart 3 or 4)

TABLE 10

| Foam Composition | MFCEM* |
|---|---|
| MFCEM Frit % wt | 50 |
| SMF % wt | 50 |
| Temp. ° C. | 850 |
| Time. min. | 45 |
| Flow chart No. | 3 & 4 |
| Result | Foam produced |

Foam glass production without using any foaming agent. Direct wet and dry method -Flow Chart 3 and 4
MFCEM*: MFCEM + SMF produce a very light foam.

TABLE 11

| | WGK | WGK/1 | WGK/2 | WGKF | WGK/3 |
|---|---|---|---|---|---|
| Waste Glass | 93.10 | 88.20 | 83.30 | 89.10 | 84.10 |
| % wt | | | | | |
| K-31 % wt | 4.90 | 9.80 | 14.70 | 4.90 | 14.90 |
| Foaming | 2.00 | 2.00 | 2.00 | 1.00 | 1.00 |
| agent | | | | | |
| % wt | | | | | |
| MF % wt | — | — | — | 5.00 | — |
| Temp ° C. | 900 | 900 | 900 | 900 | 900 |
| Time min. | 45 | 45 | 45 | 45 | 45 |
| Flow chart | 1 & 2 | 1 & 2 | 1 & 2 | 1 & 2 | 1 & 2 |
| No. | | | | | |
| Results | Foam | Foam | Foam | Foam | Foam |
| | Produced | Produced | Produced | Produced | Produced |

WGK: Waste Glass + Waste Kaolin (K-31) + Serial number
WGKF: Waste Glass + K-31 + MF + Serial number

TABLE 12

| | WGK/4 | WGK/5 | WGKF/1 | WGKF/2 |
|---|---|---|---|---|
| Waste Glass | 78.40 | 68.60 | 68.60 | 58.80 |
| % wt | | | | |
| K-31 % wt | 19.60 | 29.40 | 19.60 | 29.40 |
| MF % wt | — | — | 9.80 | 9.80 |
| Foaming | 2.00 | 2.00 | 2.00 | 2.00 |
| agent % wt | | | | |
| Temp. C.° | 900 | 900 | 900 | 900 |
| Time min. | 45 | 45 | 45 | 45 |
| Flow chart | 1 & 2 | 1 & 2 | 1 & 2 | 1 & 2 |
| No. | | | | |
| Results | No Foam | No Foam | No Foam | No Foam |
| | Produced | Produced | Produced | Produced |

Table 11 and 12 represent foam glass compositions containing different amounts of kaolin from 4.90% to 29.40% by weight replacing glass. Foams are produced in samples containing up to 14.7% by weight (sample WGK/2 of Table 11) after that no foam are produced.

TABLE 13

| | | Oxide | |
|---|---|---|---|
| Code No. | Color shade | composition | Density |
| R71211 | Dark blue | Co—Al | 4.5710 |
| R71301 | Green blue | Co—Cr—Al—Zn | 4.9430 |
| R71210 | Turquoise | Zr—Si—V | 4.0590 |
| R71622 | Red | Cd—Zr—Si—Se | — |
| R71507 | Red brown | Cr—Fe—Zn | 5.2110 |
| R71503 | Light brown | Cr—Fe—Zn—Al | 4.5570 |
| R71311 | Green | Cr—Al | 4.8500 |
| R71203 | Dark blue | Co—Si | 3.2390 |
| R71104 | Orange | Ti—Cr—Sb | 4.4510 |
| R71109 | Yellow | Zr—Si—Pr | 4.6390 |

Ceramic pigments (Stains) added physically to the foam glass composition for producing colored foam glass, using both the direct dry process (flow chart 1) and direct wet process (Flow chart 2)

TABLE 14

| | WGC-1 | WGC-2 | WGC-3 | WGC-4 |
|---|---|---|---|---|
| Mixed glass % wt | 91.00 | 91.00 | 91.00 | 91.00 |
| K-31 % wt | 3.60 | 3.60 | 3.60 | 3.60 |
| SiC % wt | 1.00 | 1.00 | 1.00 | 1.00 |
| R71311 % wt | 4.40 | — | — | — |
| R71211 % wt | — | 4.40 | — | — |
| R71104 % wt | — | — | 4.40 | — |
| R71503 % wt | — | — | — | 4.40 |
| Temperature ° C. | 900 | 900 | 900 | 900 |
| Time min. | 60 | 60 | 60 | 60 |
| Flow chart | 1 & 2 | 1 & 2 | 1 & 2 | 1 & 2 |
| Result | Foam | Foam | Foam | Foam |
| | produced | produced | produced | produced |
| Color | Green | Dark blue | Color lost | Brown |
| produced & | Good | Good | Bad | Good |
| Quality | | | | |

WGC: WASTE GLASS + K-31 + CERAMIC PIGMENT + FOAMING AGENT + SERIAL NUMBER

TABLE 15

| | WGC-5 | WGC-6 | WGC-7 | WGC-8 |
|---|---|---|---|---|
| Mix glass % wt | 90.00 | 90.00 | 90.00 | 90.00 |
| K-31 % wt | 3.60 | 3.60 | 3.60 | 3.60 |
| SiC % wt | 2.00 | 2.00 | 2.00 | 2.00 |
| R71311 % wt | 4.40 | — | — | — |
| R71211 % wt | — | 4.40 | — | — |
| R71104 % wt | — | — | 4.40 | — |
| R71503 % wt | — | — | — | 4.40 |
| Temperature ° C. | 900 | 900 | 900 | 900 |
| Time min. | 60 | 60 | 60 | 60 |
| Flow chart | 1 & 2 | 1 & 2 | 1 & 2 | 1 & 2 |
| Result | Foam | Foam | Foam | Foam |
| | produced | produced | produced | produced |
| Color & quality | Green, Good | Blue, Good | No color, | Brown, |
| | | | Bad | Good |

TABLE 16

| | WGC-9 | WGC-10 | WGC-11 | WGC-12 | WGC-13 | WGC-14 | WGC-15 | WGC-16 | WGC-17 |
|---|---|---|---|---|---|---|---|---|---|
| Flat | 45.80 | 45.00 | 45.00 | 45.40 | 45.00 | 45.80 | 46.30 | 45.00 | 45.00 |
| Glass | | | | | | | | | |
| % wt | | | | | | | | | |
| Mix | 45.80 | 45.00 | 45.00 | 45.40 | 45.00 | 45.80 | 46.30 | 45.00 | 45.00 |
| glass | | | | | | | | | |
| % wt | | | | | | | | | |
| -K 31 | 3.60 | 3.60 | 3.60 | 3.60 | 3.60 | 3.60 | 3.60 | 3.60 | 3.60 |
| % wt | | | | | | | | | |
| Foaming | 2.00 | 2.00 | 2.00 | 2.00 | 2.00 | 2.00 | 2.00 | 2.00 | 2.00 |
| agent | | | | | | | | | |
| % wt | | | | | | | | | |
| R71301 | 2.80- | — | — | — | — | — | — | — | |
| % wt | | | | | | | | | |
| R71210 | — | 4.40- | — | — | — | — | — | | — |
| % wt | | | | | | | | | |
| R71622 | | — | 4.40- | — | — | — | — | — | — |
| % wt | | | | | | | | | |
| R71507 | — | — | — | 3.60- | — | — | | — | — |
| % wt | | | | | | | | | |
| R71503 | — | — | — | — | 4.40- | | — | — | — |
| % wt | | | | | | | | | |
| R71311 | — | — | — | — | | 2.80- | — | — | — |
| % wt | | | | | | | | | |
| R71203 | — | — | — | | — | — | 1.80- | — | — |
| % wt | | | | | | | | | |
| R71104 | — | | — | — | — | — | — | 4.40- | — |
| % wt | | | | | | | | | |
| R71109 | — | — | | — | — | — | — | — | 4.40- |
| % wt | | | | | | | | | |
| Temp. ° C. | 900 | 900 | 900 | 900 | 900 | 900 | 900 | 900 | 900 |
| Time | 60 | 60 | 60 | 60 | 60 | 60 | 60 | 60 | 60 |
| min. | | | | | | | | | |
| Flow | 1 & 2 | 1 & 2 | 1 & 2 | 1 & 2 | 1 & 2 | 1 & 2 | 1 & 2 | 1 & 2 | 1 & 2 |
| chart | | | | | | | | | |
| Result | Foam | Foam | Foam | Foam | Foam | Foam | No foam | Foam | Foam |
| | produced | produced | produced | produced | produced | produced | produced | produced | produced |
| Color & | Blue | Turquoise | Red | Red | Light | Green | Blue | Orange | Yellow |
| Quality | green | no-good | no- | brown | brown | very | failed | no-good | no- |
| | good | | good | very | very | good | | | good |
| | | | | good | good | | | | |

TABLE 17

| | WGC-18 | WGC-19 | WGC-20 | WGC-21 | WGC-22 | WGC-23 | WGC-24 | WGTC-1 | WGTC-2 | WGTC-3 | WGTC-4 |
|---|---|---|---|---|---|---|---|---|---|---|---|
| Flat glass | 81.00 | 72.00 | 63.00 | 54.00 | 45.00 | 36.00 | 27.00 | 40.00 | 36.00 | 45.00 | 45.00 |
| % wt | | | | | | | | | | | |
| Mix Glass | 9.00 | 18.00 | 27.00 | 36.00 | 45.00 | 54.00 | 63.00 | 40.00 | 36.00 | 27.00 | 35.00 |
| % wt | | | | | | | | | | | |
| K-31 % wt | 7.20 | 7.20 | 7.20 | 7.20 | 7.20 | 7.20 | 7.20 | 7.20 | 7.20 | 7.20 | 7.20 |
| SiC % wt | 2.00 | 2.00 | 2.00 | 2.00 | 2.00 | 2.00 | 2.00 | 2.00 | 2.00 | 2.00 | 2.00 |
| R71311 | 0.80 | 0.80 | 0.80 | 0.80 | 0.80 | 0.80 | 0.80 | 0.80 | 0.80 | 0.80 | 0.80 |
| % wt | | | | | | | | | | | |
| F-38 % wt | — | — | — | — | — | — | — | 10.0 | 18.0 | 18.0 | 10.0 |
| Temp. ° C. | 900 | 900 | 900 | 900 | 900 | 900 | 900 | 900 | 900 | 900 | 900 |
| Time min. | 60 | 60 | 60 | 60 | 60 | 60 | 60 | 30 | 30 | 30 | 30 |
| Flow chart | 1 & 2 | 1 & 2 | 1 & 2 | 1 & 2 | 1 & 2 | 1 & 2 | 1 & 2 | 1 & 2 | 1 & 2 | 1 & 2 | 1 & 2 |
| Result | Foam | Foam | Foam | Foam | Foam | No | No | Foam | Foam | Foam | Foam |
| | produced | produced | produced | produced | produced | foam | foam | produced | produced | produced | produced |
| | | | | | | produced | produced | | | | |
| Color & | Green | Green | Green | Green- | Green- | Green- | Green | Green | Green | Green | Green |
| Quality | good | good | good | good | no | no | no | Very | very | very | very |
| | | | | | good | good | good | good | good | good | good |

WGTC—waste glass + Transparent frit + Ceramic pigment + K-31(Kaolin) + SiC + Serial

TABLE 18

| | Code | | | | | | | | |
|---|---|---|---|---|---|---|---|---|---|
| | WGTFC | WGTFC-1 | WGTC-5 | WGFC | WGFOC | WGFOC-1 | WGOC | WGC-25 | WGC-26 |
| Flat | 50 | 50 | 50 | 50 | 50 | 50 | 50 | 75 | 100 |
| glass | | | | | | | | | |
| % wt | | | | | | | | | |
| Mix | 40 | 30 | 30 | 30 | 40 | 30 | 30 | 25 | 0 |
| glass | | | | | | | | | |
| % wt | | | | | | | | | |
| F-38 | 5 | 10 | 20 | — | — | — | — | — | — |
| % wt | | | | | | | | | |
| MF | 5 | 10 | — | 20 | 5 | 10 | — | — | — |
| % wt | | | | | | | | | |
| K-31 | 4 | 4 | 4 | 4 | 4 | 4 | 4 | 4 | 4 |
| % wt | | | | | | | | | |
| 3-655/2 | — | — | — | — | 5 | 10 | 20 | — | — |
| % wt | | | | | | | | | |
| R71503 | 3 | 3 | 3 | 3 | 3 | 3 | 3 | 3 | 3 |
| % wt | | | | | | | | | |
| SiC | 2 | 2 | 2 | 2 | 2 | 2 | 2 | 2 | 2 |
| % wt | | | | | | | | | |
| Temp. | 900 | 900 | 900 | 900 | 900 | 900 | 900 | 900 | 900 |
| ° C. | | | | | | | | | |
| Time | 30 | 30 | 30 | 30 | 30 | 30 | 30 | 60 | 60 |
| min. | | | | | | | | | |
| Flow | 1 & 2 | 1 & 2 | 1 & 2 | 1 & 2 | 1 & 2 | 1 & 2 | 1 & 2 | 1 & 2 | 1 & 2 |
| chart | | | | | | | | | |
| Result | Foam | Foam | Foam | Foam | Foam | Foam | Foam | Foam | Foam |
| | produced | produced | produced | produced | produced | produced | produced | produced | produced |
| Color & | Light | Light | Light | Light | Light | Light | Light | Light | Light |
| quality | brown | brown | brown | brown | brown | brown | brown | brown | brown |
| | good | good | very | good | good | good | Very | good | Good |
| | | | good | | | | good | | |

TABLE 19

| | WGTFC-2 | WGTFC-3 | WGTFC-4 | WGTFC-5 | WGTFC-6 | WGTFC-7 | WGTFC-8 | WGTFC-9 | WGTFC-10 |
|---|---|---|---|---|---|---|---|---|---|
| F-38 | 59.00 | 59.00 | 59.00 | 59.00 | 59.00 | 59.00 | 59.00 | 59.00 | 59.00 |
| % wt | | | | | | | | | |
| Flat | 17.20 | 15.60 | 16.40 | 15.60 | 15.60 | 17.20 | 18.20 | 15.60 | 15.60 |
| glass | | | | | | | | | |
| % wt | | | | | | | | | |
| MF % wt | 12.00 | 12.00 | 12.00 | 12.00 | 12.00 | 12.00 | 12.00 | 12.00 | 12.00 |
| K-31 | 6.00 | 6.00 | 6.00 | 6.00 | 6.00 | 6.00 | 6.00 | 6.00 | 6.00 |
| % wt | | | | | | | | | |
| SiC | 2.00 | 2.00 | 2.00 | 2.00 | 2.00 | 2.00 | 2.00 | 2.00 | 2.00 |
| % wt | | | | | | | | | |
| R71301 | 2.80 | | | | | | | | |
| % wt | | | | | | | | | |
| R71210 | | 4.40 | | | | | | | |
| % wt | | | | | | | | | |
| R71622 | | | 4.40 | | | | | | |
| % wt | | | | | | | | | |
| R71507 | | | | 3.60 | | | | | |
| % wt | | | | | | | | | |
| R71503 | | | | | 4.40 | | | | |
| % wt | | | | | | | | | |
| R71311 | | | | | | 2.80 | | | |
| % wt | | | | | | | | | |
| R71203 | | | | | | | 1.80 | | |
| % wt | | | | | | | | | |
| R71104 | | | | | | | | 4.40 | |
| % wt | | | | | | | | | |
| R71109 | | | | | | | | | 4.40 |
| % wt | | | | | | | | | |
| Iron | 1.00 | 1.00 | 1.00 | 1.00 | 1.00 | 1.00 | 1.00 | 1.00 | 1.00 |
| oxide | | | | | | | | | |
| % wt | | | | | | | | | |
| Temp. | 900 | 900 | 900 | 900 | 900 | 900 | 900 | 900 | 900 |
| ° C. | | | | | | | | | |
| Time | 30 | 30 | 30 | 30 | 30 | 30 | 30 | 30 | 30 |
| Min. | | | | | | | | | |
| Flow | 1 & 2 | 1 & 2 | 1 & 2 | 1 & 2 | 1 & 2 | 1 & 2 | 1 & 2 | 1 & 2 | 1 & 2 |
| chart | | | | | | | | | |
| Result | Foam | Foam | Foam | Foam | Foam | Foam | Foam | Foam | Foam |
| | produced | Produced | Produced | Produced | Produced | Produced | Produced | Produced | Produced |
| Color & | Green- | Turquoise | Red | Red- | Light- | Green | Dark- | Orange | Yellow |
| Quality | blue | blue | Excellent | brown | brown | Excellent | blue | Very | Very |
| | Excellent | Very | | Excellent | Excellent | | Very | good | good |
| | | good | | | | | good | | |

TABLE 20

| | WGTVC | WGTVC-1 | WGTVC-2 | WGTVC-3 | WGTVC-4 | WGTVC-5 |
|---|---|---|---|---|---|---|
| Flat glass | 51.80 | 51.80 | 51.80 | 51.80 | 51.80 | 51.00 |
| % wt | | | | | | |
| Mix glass | 19.00 | 19.00 | 19.00 | 19.00 | 19.00 | 19.00 |
| % wt | | | | | | |
| K-31 % wt | 4.50 | 4.70 | 4.70 | 4.70 | 4.70 | 4.70 |
| SiC % wt | 2.00 | 2.00 | 2.00 | 2.00 | 2.00 | 2.00 |
| R71301 % wt | — | | | | — | 3.70 |
| R71210 % wt | — | | | | 3.70 | — |
| R71622 % wt | — | 3.70 | — | — | — | — |
| R71507 % wt | — | — | — | 3.70 | — | — |
| R71503 % wt | — | — | 3.70 | — | — | — |
| R71311 % wt | 3.70 | — | — | — | — | — |
| Front glass | 19.00 | 19.00 | 19.00 | 19.00 | 19.00 | 19.00 |
| % wt | | | | | | |
| Temp. ° C. | 850 | 850 | 850 | 850 | 850 | 850 |
| Time, Minute | 30 | 30 | 30 | 30 | 30 | 30 |
| Flow chart | 1 & 2 | 1 & 2 | 1 & 2 | 1 & 2 | 1 & 2 | 1 & 2 |
| Result | Foam | Foam | Foam | Foam | Foam | Foam |
| | produced | produced | produced | produced | produced | produced |
| Color & | Green-very | Red-good | Light brown | Red brown | Turquoise | Green |
| quality | good | | very good | very good | very good | blue very |
| | | | | | | good |

TABLE 21

| | WGTV/ | WGTV/ | WGTV/ | WGTV/ | WGTV/ | WGTV/ | WGTV/ | WGTV/ | WGTV/ | WGTV/ |
|---|---|---|---|---|---|---|---|---|---|---|
| | Cu | Cu/1 | Co | Co/1 | Co/2 | Cr | Cr/1 | Cr/2 | Mn | Mn/1 |
| Flat glass | 78.50 | 75.50 | 76.50 | 76.00 | 75.50 | 76.50 | 76.00 | 75.50 | 78.50 | 75.50 |
| % wt | | | | | | | | | | |
| Front | 18.50 | 18.50 | 23.00 | 23.00 | 23.00 | 23.00 | 23.00 | 23.00 | 18.50 | 18.50 |
| monitor | | | | | | | | | | |
| % wt | | | | | | | | | | |
| Copper | 3.00 | 6.00 | — | — | — | — | — | — | — | — |
| oxide | | | | | | | | | | |
| % wt | | | | | | | | | | |
| Cobalt | — | — | 0.50 | 1.00 | 1.50 | — | — | — | — | — |
| oxide | | | | | | | | | | |
| % wt | | | | | | | | | | |
| Chrome | — | — | — | — | — | 0.500 | 1.00 | 1.50 | — | — |
| oxide | | | | | | | | | | |
| % wt | | | | | | | | | | |
| Manganese | — | — | — | — | — | — | — | — | 3.00 | 6.00 |
| oxide | | | | | | | | | | |
| % wt | | | | | | | | | | |
| Quality & | Good | Good | Good | Good | Good | Good | Good | Good | Good | Good |
| Frit color | Light | Blue | Blue | Blue | dark | green | green | dark | light | brown |
| | blue | | | | blue | | | green | brown | |

TABLE 22

| | WGTV/ | WGTV/ | WGTV/ | WGTV/ | WGTV/ | WGTV/ | WGTV/ | WGTV/ | WGTV/ | WGTV/Mn/ |
|---|---|---|---|---|---|---|---|---|---|---|
| | Cu* | Cu/1 * | Co * | Co/1 * | Co/2 * | Cr * | Cr/1* | Cr/2* | Mn* | 1* |
| Color | WGTV/ | WGTV/ | WGTV/ | WGTV/ | WGTV/ | WGTV/ | WGTV/ | WGTV/ | WGTV/ | WGTV/Mn/1 |
| fritted | Cu | Cu/1 | Co | Co/1 | Co/2 | Cr | Cr/1 | Cr/2 | Mn | 95.0 |
| glass | 95.0 | 95.0 | 95.0 | 95.0 | 95.0 | 95.0 | 95.0 | 95.0 | 95.0 | |
| % wt | | | | | | | | | | |
| SiC % wt | 1.00 | 1.00 | 1.00 | 1.00 | 1.00 | 1.00 | 1.00 | 1.00 | 1.00 | 1.00 |
| K-31 | 4.00 | 4.00 | 4.00 | 4.00 | 4.00 | 4.00 | 4.00 | 4.00 | 4.00 | 4.00 |
| % wt | | | | | | | | | | |
| Temperature | 850 | 850 | 850 | 850 | 850 | 850 | 850 | 850 | 850 | 850 |
| ° C. | | | | | | | | | | |
| Time | 45 | 45 | 45 | 45 | 45 | 45 | 45 | 45 | 45 | 45 |
| min. | | | | | | | | | | |
| Flow | 3 & 4 | 3 & 4 | 3 & 4 | 3 & 4 | 3 & 4 | 3 & 4 | 3 & 4 | 3 & 4 | 3 & 4 | 3 & 4 |
| chart | | | | | | | | | | |
| Result | Foam | Foam | Foam | Foam | Foam | Foam | Foam | Foam | Foam | Foam produced |
| | produced | produced | produced | produced | produced | produced | produced | produced | produced | |
| Color & | Light | Blue | Blue | Blue | Dark | Green | Green | Dark | Light | Brown |
| Quality | blue | good | good | good | blue | good | good | green | brown | Very good |
| | good | | | | good | | | good | good | |

TABLE 23

| 820° C./30 Min | SMFFC | SMFFC-1 | SMFFC-2 | SMFFC-3 | SMFFC-4 | SMFFC-5 | SMFFC-6 |
|---|---|---|---|---|---|---|---|
| SMF % wt | 58.5 | 57.0 | 57.0 | 57.0 | 57.0 | 58.5 | 42.0 |
| MF % wt | 20.0 | 20.0 | 20.0 | 20.0 | 20.0 | 20.0 | 45.0 |
| K-31% wt | 20.0 | 20.0 | 20.0 | 20.0 | 20.0 | 20.0 | 10.0 |
| R71503% wt | 1.5 | — | — | — | — | — | — |
| R71503% wt | — | 3.0 | — | — | — | — | — |
| R7121% wt | — | — | 3.0 | — | — | — | — |
| R71203% wt | — | — | | 3.0 | — | — | — |
| R71202% wt | — | — | | | 3.0 | — | — |
| R71301% wt | — | — | | | | 1.5 | — |
| R71301% wt | — | — | | | | | 3.0 |
| R71507% wt | — | — | | | | | |
| R71222% wt | — | — | | | | | |
| Chromium | | | | | | | |
| oxide % wt | | | | | | | |
| Cobalt | — | — | | | | | |
| oxide % wt | | | | | | | |
| Copper | — | — | | | | | |
| oxid % wt | | | | | | | |
| Iron oxide | — | — | | | | | |
| % wt | | | | | | | |
| Temp. ° C. | 800 | 800 | 800 | 800 | 800 | 800 | 800 |
| Time min. | 30 | 30 | 30 | 30 | 30 | 30 | 30 |
| Flow chart | 3 & 4 | 3 & 4 | 3 & 4 | 3 & 4 | 3 & 4 | 3 & 4 | 3 & 4 |

| | | | SMFFC*/ | SMFFC*/ | SMFFC*/ | SMFFC*/ |
|---|---|---|---|---|---|---|
| 820° C./30 Min | SMFFC-7 | SMFFC-9 | 2/Cr | 2/Co | 2/Cu | 2/Fe2O3 |
| SMF % wt | 44.0 | 44.0 | 43.5 | 43.5 | 42.0 | 37.0 |
| MF % wt | 45.0 | 45.0 | 45.0 | 45.0 | 45.0 | 45.0 |
| K-31% wt | 10.0 | 10.0 | 10.0 | 10.0 | 10.0 | 10.0 |
| R71503% wt | — | — | — | — | — | — |
| R71503% wt | — | — | — | — | — | — |
| R7121% wt | — | — | — | — | — | — |
| R71203% wt | — | — | — | — | — | — |
| R71202% wt | — | — | — | — | — | — |
| R71301% wt | — | — | — | — | — | — |
| R71301% wt | — | — | — | — | — | — |
| R71507% wt | 1.0 | — | — | — | — | — |
| R71222% wt | | 1.0 | — | — | — | — |
| Chromium | | | 1.5 | — | — | — |
| oxide % wt | | | | | | |
| Cobalt | | | | 1.5 | — | — |
| oxide % wt | | | | | | |
| Copper | | | | | 3.0 | — |
| oxid % wt | | | | | | |
| Iron oxide | | | | | — | 8.0 |
| % wt | | | | | | |
| Temp. ° C. | 800 | 800 | 800 | 800 | 800 | 800 |
| Time min. | 30 | 30 | 30 | 30 | 30 | 30 |
| Flow chart | 3 & 4 | 3 & 4 | 3 & 4 | 3 & 4 | 3 & 4 | 3 & 4 |

TABLE 24
Materials names and their broad range of application in different formulas. in weight
percentage

| | |
|---|---|
| Flat waste glass | 20-25-30-35-40-45--54-69.-70.-80.-85.-90.95.98.% |
| | by weight |
| Mix glass | 5.0-10.0-15.0-20.0-25.0-30.0-35.0-40.0-45.0-50.0-98.0% |
| | by weight |
| Transparent waste frit (F-38) | 10.0-15.0-20.0-50.0-60.0-75.0-80.0% |
| | by weight |
| Opaque waste frit (3-655/2) | 10.0-15.0-20.0-50.0-60.0-75.0-80.0-98.0% |
| | by weight |
| MF Frit | 5.0-10.0-15.0-20.0-30.0-40.0-45.0% by weight |
| CRT flat glass | 10.0-20.0-30.0-40.0-50-.0 80-.0 98.0% by weight |
| CRT funnel glass | 20.0-25.0-30.0-50.0-75.0-90.0-98.0% by weight |
| Porcelain Waste | 5.0-10.0-20.0-30.0% by weight |
| Tile Waste | 5.0-10.0-20.0-30.0% by weight |
| Building refused cement and concrete | 20.0-40.0% |
| Waste Kaolin, K-31. | 5.0-10.0-12.0-12.5-15.0-20.0-30.0% by weight |
| SiC | 0-1.0-2.0-3.0-4.0-5.0-7.5-10.0% |
| | by weight |
| Slag | 7.0-8.5-16.0-22.0-31.0-39.0% by weight |
| SMF Frit | 15.0-35.0-37.0-40.0-42.0-43.5-44.0-45.0-55.0-58.5-65.0-75.0-85.0-95.0-% |
| | by weight |
| Colors | 0.8, 1.5-3.0-4.5-6.0-7.5-9.0% by weight |
| Transition Metal oxide | CuO, Fe2O3, CoO, Cr2O3, MnO, 0.5-1-2-3-5-6-8 |
| | by weight |
| Firing Temperature | 800, 825, 850, 875, 900, ° C. |
| Firing time | 30-45-60-90 minutes. |

Therefore what is claimed is:

1. A process of producing a foam glassy material produced pre-selected physical, structural, mechanical and chemical properties, comprising the steps of:
a) providing a precursor foam glassy formulation, the precursor foam glassy formulation comprising a micronized glassy material, said micronized glassy material being any one or any combination of ceramic opaque frits, transparent frits, flux frit, glazes, waste from kaolin processing, porcelain waste products, slag, cement, concrete, waste tile products, foaming agents; and
b) processing the precursor foam glass formulation to form foam glass, including a step of firing the precursor foam glassy formulation to a temperature in a range from about 800° C. to about 900° C., followed by a step of annealing, followed by a step of cooling to produce a foam glassy product.

2. The process according to claim 1, wherein after step a) including a step of shaping the precursor foam glassy formulation in a shape to give a desired shape to the foam glassy product.

3. The process according to claim 1, wherein after step a) including a step of mixing water with the precursor foam glassy formulation.

4. The process according to claim 3, wherein after the step of mixing water with the precursor foam glassy formulation, including a step of shaping the precursor foam glassy formulation in a shape to give a desired shape to the foam glassy product, and prior to step b), including a step of removing water from the shaped precursor foam glassy formulation.

5. The process according to claim 1, wherein the micronized glassy material, said micronized glassy material being any one or any combination of opaque frits, transparent frits, and glazes selected on the basis that each includes any one or combination of boron oxide, aluminum oxide, zinc oxide and zirconium oxide.

6. The process according to claim 1, wherein the precursor foam glassy formulation includes glass.

7. The method according to claim 1 wherein said precursor foam glassy formulation further comprises a coloring agent, and wherein said foam glassy product is a colored foam glass product.

8. The method according to claim 7 wherein said precursor foam glassy formulation includes at least slag and opaque frits in addition to foaming agents, said slag having been subjected to melting, fritting, grinding and micronizing to produce a glassy constituent, and wherein said coloring agent is a ceramic pigment having a preselected color, and wherein said foam glassy product has a pastel color.

9. The method according to claim 7 wherein said precursor foam glass formulation includes at least slag and opaque frits in addition to foaming agents and a transition metal oxide coloring agent, and wherein said slag and transition metal coloring agent having been subjected to melting, fritting, grinding and micronizing to produce a self-colored glassy constituent, and wherein said foam glass product has a color reflective of said transition metal coloring agent.

10. The method according to claim 7 wherein said precursor foam glass formulation includes at least transparent frits and glazes, and wherein said coloring agent is a ceramic pigment having a preselected color, and wherein said foam glass product has a bright deep color.

11. A process according to claim 1, comprising the steps of:
a) producing a slip mixture by mixing a preselected amount of the micronized glassy material with a preselected amount of water and a preselected amount of a foaming agent;
b) producing a milled slip mixture by mixing and milling the slip mixture to give particles in the slip mixture a size in a preselected range;
c) sieving the milled slip mixture to remove particles having a size larger than a preselected threshold size; and
d) shaping the milled slip mixture into a desired shape and drying, firing and annealing the shaped milled slip mixture to produce a foam glass product.

12. The process according to claim 11 wherein said step d) of shaping the milled slip mixture includes preparing a mold from a water absorbent material having a preselected size and shape, pouring the milled slip mixture into the mold and letting the milled slip mixture set wherein at least some of the water in the milled slip mixture is absorbed by the water absorbent material of the mold, separating the mold from the set milled slip mixture, drying and firing the set milled slip mixture to produce the foam glass product.

13. The process according to claim 12 wherein said water absorbent material is plaster of Paris.

14. The method according to claim 11 wherein said step d) of shaping the milled slip mixture includes filter pressing the milled slip mixture and placing the filter pressed milled slip mixture into an extruder, the extruder having an extrusion die with a selected cross section profile, extruding the filter pressed milled slip mixture to produce an extruded, drying and firing the extruded, and annealing the fired extruded to produce the foam glass product having the selected cross section profile.

15. The process according to claim 14 wherein said extruder die is shaped to produce cylindrical foam glass product.

16. The process according to claim 14 wherein said extruder die is shaped to produce hollow, tubular foam glass product.

17. The process according to claim 11 wherein said step d) of shaping the milled slip mixture includes spray drying the milled slip mixture to produce a dry powdered material and placing the dry powder material into a metal mold and firing the powder to produce granules of the foam glass product.

18. The process according to claim 1 wherein the at least one of the precursor foam glassy formulation comprising a micronized glassy material includes a non-glassy or partially glassy constituent, and wherein step a)
i) includes first melting and fritting the non-glassy or partially glassy constituent at a temperature in a range from about 1200 to about 1400° C. to produce a fritted glassy constituent and micronizing the fritted glassy constituent;
ii) including producing a slip mixture by mixing a preselected amount of the micronized fritted non-glassy constituent with a preselected amount of a micronized glassy material and a preselected amount of water and a preselected amount of a foaming agent;
iii c) producing a milled slip mixture by mixing and milling the slip;
iv d) sieving the milled slip mixture to remove particles having a size larger than a preselected threshold size; and
v e) shaping the milled slip mixture into a desired shape and drying, firing and annealing the shaped milled slip mixture to produce a foam glass product.

19. The process according to claim 18 wherein said step v) of shaping the milled slip mixture includes preparing a mold from a water absorbent material having a preselected size and shape, pouring the milled slip mixture into the mold and letting the milled slip mixture set wherein at least some of the water in the milled slip mixture is absorbed by the water absorbent material of the mold, separating the mold from the set milled slip mixture, drying and firing the set milled slip mixture to produce the foam glass product.

20. The process according to claim 19 wherein said water absorbent material is plaster of Paris.

21. The process according to claim 18 wherein said step v) of shaping the milled slip mixture includes filter pressing the milled slip mixture and placing the filter pressed milled slip mixture into an extruder, the extruder having an extrusion die with a selected cross section profile, extruding the filter pressed milled slip mixture to produce an extrudate, drying and firing the extrudate and annealing the fired extrudate to produce the foam glass product having the selected cross section profile.

22. The process according to claim 21 wherein said extruder die is shaped to produce cylindrical foam glass product.

23. The method according to claim 21 wherein said extruder die is shaped to produce hollow, tubular foam glass product.

24. The method according to claim 18 wherein said step v) of shaping the milled slip mixture includes spray drying the milled slip mixture to produce a dry powdered material and placing the dry powder material into a metal mold and firing the powder to produce granules of the foam glass product.

25. The method according to claim 18 wherein said non-glassy or partially glassy material is any one or combination of blast furnace slag, raw ceramic material, fired glazed ceramic material, non-glazed ceramic body including earthenware, stoneware or porcelain tile, sanitary ware, soft or hard porcelain, cement, concrete, bricks, mineral wastes from mines, ceramic and glass waste from ceramic and glass.

26. The method according to claim 18 wherein said non-glassy or partially glassy materials are present in an range of about 1% by weight to about 90% by weight in the foam glass product.

27. A method of producing a foam glassy product from glassy materials and/or non-glassy or partially glassy materials, comprising the steps of:
a) providing a non-glassy and/or partially glassy material and melting and fritting the non-glassy material at a temperature in a range from about 1200 to about 1400° C. to produce a fritted glassy constituent and micronizing the fritted glassy constituent;
b) mixing a preselected amount of the micronized fritted glassy constituent with a preselected amount of a micronized glassy material and a preselected amount of a foaming agent to form a foam glassy formulation;
c) mixing and dry milling the foam glassy formulation for producing a milled dry powder mixture;
d) sieving the milled dry powder mixture to remove particles having a size larger than a preselected threshold size; and
e) shaping the sieved dry powder mixture into a desired shape and firing and annealing the shaped sieved dry powder mixture to produce a foam glassy product.

28. The method according to claim 27 wherein said step e) of shaping the sieved dry powder mixture includes placing the sieved dry powder mixture into a metal mold and firing the powder to produce an article of the foam glass product having a size and shape reflective of the metal mold.

29. The method according to claim 27 wherein said step e) of shaping the sieved dry powder mixture includes granulating the sieved dry powder mixture, drying and firing the granulated sieved dry power mixture, cooling and sieving the granulated sieved dry power mixture to produce foam glass granulated particles.

30. The process according to claim 29 wherein said non-glassy or partially glassy material is any one or combination of blast furnace slag, raw ceramic material, fired glazed ceramic material, non-glazed ceramic body including earthenware, stoneware or porcelain tile, sanitary ware, soft or hard porcelain, cement, concrete, bricks, mineral wastes from mines, ceramic and glass waste from ceramic and glass.

31. The process according to claim 30 wherein said non-glassy materials are present in an range of about 1% by weight to about 90% by weight in the foam glassy product.
